(19) United States
(12) Patent Application Publication
(10) Pub. No.: US 2019/0114710 A1
(43) Pub. Date: Apr. 18, 2019

(54) SEMI-PARAMETRIC APPROACH TO LARGE-SCALE PORTFOLIO OPTIMIZATION WITH FACTOR MODELS OF ASSET RETURNS

(71) Applicant: Gerd Infanger, Palo Alto, CA (US)

(72) Inventor: Gerd Infanger, Palo Alto, CA (US)

(21) Appl. No.: 15/785,360

(22) Filed: Oct. 16, 2017

(51) Int. Cl. G06Q 40/06; G06F 17/13; G06F 17/18

(52) U.S. Cl. CPC G06Q 40/06; G06F 17/18; G06F 17/13

(57) ABSTRACT

An approach to large-scale portfolio optimization for asset returns represented by factor models is disclosed. Factor models can be used within general portfolio optimization problems, such as mean-variance optimization, expected utility maximization, and mean-risk optimization, with various measures of risk, including conditional Value-at-Risk, as well as the representation of risk constraints and constraints on higher moments of the asset return distribution. Both expected utility maximization and mean-risk optimization are more general than mean-variance optimization and can consider fat tails in the asset return distribution and, thus, allow for better control of downside risk. Explicit risk constraints especially constraints on conditional Value-at-Risk, limit downside risk in either mean-variance optimization, expected utility maximization, or mean-risk optimization. Constraints on higher moments limit fat tails of the asset return distribution. Equilibrium returns in expected utility maximization and mean-variance optimization based on factor models of asset returns are obtained. Active management of portfolios of financial assets based on factor exposures is provided.

### BACKGROUND OF THE INVENTION

### Field of the Invention

The present invention relates generally to a system and method for management of a portfolio of financial assets and, more particularly, to large-scale portfolio optimization. Specifically, various embodiments in accordance with the present invention provide a system and method for modeling and solving large-scale portfolio optimization problems, including mean-variance optimization, expected utility maximization, and general mean-risk optimization problems.

### Description of the Prior Art

Since H. Markowitz, Portfolio selection, Journal of Finance, 7(1): 77-91, 1952, portfolio management problems are routinely formulated and solved as mean-variance portfolio optimization problems, where the expected return of a portfolio is traded off with its risk and where risk is represented as portfolio variance. Let \tilde{R} be the random n-vector of asset returns. The mean-variance portfolio optimization problem may be stated as

$${max ( E \tilde{R} )}^{T} x - \frac{γ}{2} {x}^{T} M x$$

$$Ax = b , l \leq x \leq h$$

where E\tilde{R} is the n-vector of expected asset returns; M=[Mᵢⱼ] is the n×n covariance matrix of asset returns (Mᵢⱼ=cov(\tilde{R}ᵢ,\tilde{R}ⱼ)), γ is the risk aversion parameter, Ax=b are linear constraints, and l and h are lower and upper bounds on asset holdings. The formulation Ax=b may include a portfolio constraint e^{T}x=1, for modeling both long-only and long-short portfolios and/or more elaborate constraints for controlling the leverage of long-short portfolios. It may also include sector exposure constraints, industry exposure constraints, transaction cost modeling, turnover constraints, and any constraints related to a piecewise-linear market impact model representation.

Using mean-variance optimization is particularly appropriate when asset returns are approximately multi-variate normally distributed, i.e., \tilde{R}≈N(E\tilde{R}, M), since in this case the distribution is fully determined by E\tilde{R} and M only and all higher moments are either zero (odd) or monotonically determined by M (even). But it is also appropriate to use when asset returns are not approximately multi-variate normally distributed but an investor only cares about portfolio variance (or tracking error) as a measure of risk. By varying the risk aversion parameter γ from zero to a very large number, one may determine the optimal efficient frontier from the point of considering expected returns only (γ=0) to the point of the minimum variance portfolio (γ=∝).

A related, more general, concept is expected utility maximization. Let u(W) be a concave utility function of wealth (W). The expected utility maximization problem may be stated as

max E u(1+\tilde{R}^{T}x)

Ax=b,l≤x≤h

where, given an initial wealth normalized to 1, the end-of-period wealth is given by the random variable W=1+\tilde{R}^{T}x and evaluated by the utility function u(W). Typically, the utility function is assumed to be monotonically increasing and concave. The functional form of the utility function u(W), in particular, the ArrowPratt risk aversion; see K. J. Arrow, Aspects of the theory of risk bearing, Essays on the Theory of Risk Bearing, Markham, Chicago, pages 90-109, 1965 and J. W. Pratt, Risk aversion in the small and in the large, Econometrica, 32, pages 122-136, 1964, a measure of the second derivative of the utility function, represents the investor preference. Utility functions frequently used are from the HARA (hyperbolic absolute risk aversion) class of utility functions. Often in finance the power function is used, i.e.,

$$u ( W ) = \frac{{W}^{1 - γ} - 1}{1 - γ} ,$$

where γ≥0 and γ≠1. Here γ
represents the constant (with respect to wealth) relative risk aversion parameter describing the investor preference towards risk. Therefore, the power function is typically referred to as CRRA (constant relative risk aversion). Another utility function in the HARA class is the exponential utility function u(W)=−e^{-λW}, where λ represents the constant (with respect to wealth) absolute risk aversion parameter. The exponential utility function is also referred to as CARA (constant absolute risk aversion). The logarithmic utility function u(W)=log(W) is a special case of the power function for the limit of the risk, aversion γ=1. The latter has the property of maximizing growth in a multi-period setting. A generalization is the generalized log utility function u(W)=log(a+W), where, by proper choice of a, increasing and decreasing relative risk aversion may be modeled; see M. Rubin-stein, Risk aversion in the small and in the large, Econometrics, pages 32:122-136, 1965. The above-mentioned functions exhaust the class of HARA utility functions. An one-switch class of utility functions is given by D. Bell, One switch utility functions and a measure of risk. Management Science, 24(12):1416-1424, 1965. Other utility functions that are not necessarily monotonically increasing and concave have been devised to represent specific investor risk preferences; see D. Kahnemann and A. Tversky, Prospect theory: An analysis of decisions under risk, Econometrics, 47(2), pages 263-291, 1979. These are important for determining individualized portfolios.

Expected utility maximization facilitates the appropriate representation of all higher moments (skewness, kurtosis, etc.) of the asset return distribution in the portfolio optimization framework. It can be shown that if the utility function is quadratic (using only the increasing part of the quadratic function), the expected utility maximization problem results in a mean-variance optimization problem and therefore gives identical results. Any other utility function will yield different results, when asset returns are not multi-variate normally distributed. If asset returns are multi-variate normally distributed, any monotonically increasing and concave utility function will yield a mean-variance efficient portfolio. One expects different results for expected utility maximization than mean-variance analysis when asset returns are not multi-variate normally distributed and the utility function is not quadratic. But the differences in the portfolios may be small, as Y. Kroll, H. Levy, and H. Markowitz, Mean-variance versus direct utility maximization, Journal of Finance, 39(1), pages 47-61, 1984, argued. Since one may locally approximate any utility function by a quadratic approximation, the mean-variance model will in most cases give reasonable results even for asset returns not following a multi-variate normal distribution. This explains the great success of mean-variance portfolio optimization. However, tail behavior might be very different.

A generalization of the mean-variance framework is mean-risk portfolio optimization. The mean-risk portfolio optimization problem may be stated as

$${max ( E \tilde{R} )}^{T} x - \frac{γ}{2} Risk ( {\tilde{R}}^{T} x )$$

$$Ax = b , l \leq x \leq h$$

where Risk(\tilde{R}^{T}x) is a risk measure on the distribution of portfolio returns \tilde{R}^{T}x. In mean-variance portfolio optimization the risk measure used is portfolio variance, i.e., Risk(\tilde{R}^{T}x)=var(\tilde{R}^{T}x)=E(\tilde{R}^{T}x−E(\tilde{R}^{T}x))²=x^{T}Mx. Mean-variance optimization is therefore part of the broader class of mean-risk portfolio optimization, where various risk measures are considered.

Risk measures are typically either dispersion measures or downside risk measures. Variance is a dispersion measure. Another dispersion measure is the mean-absolute-deviation measure (MAD), introduced by H. Konno and H. Yamazaki, Mean-absolute deviation portfolio optimization model and its application to Tokyo stock market, Management Science, 37(5), pages 519-531, 1991. Typical downside risk measures are the semi-variance and variants of lower partial moments. But most important in finance are the tail measures Value-at-Risk (VaR) and Conditional-Value-at-Risk (CVaR).

In addition to considering a risk measure in the objective function, risk, especially downside risk, may also be controlled as a constraint. For example,

Risk(\tilde{R}^{T}x)≤ρ

may be a constraint added to the mean-variance portfolio optimization problem or to the expected utility portfolio optimization problem, where ρ is the maximum level of acceptable risk as defined by the risk measure Risk. Special risk constraints may involve higher moments of the returns distribution, in particular, one may constrain the skewness and/or the kurtosis of the returns distribution.

### SUMMARY OF THE INVENTION

Various embodiments in accordance with the present invention provide a system and method for efficiently solving general classes of large-scale financial asset portfolio optimization problems. Preferred embodiments of the system and method in accordance with the present invention solve the general portfolio optimization problem, employing a factor representation of asset returns. Various embodiments in accordance with the present invention calibrate the optimization model to a benchmark to obtain unconditional mean returns and enable active management based on conditional expected return predictions. Various additional embodiments of the system and method in accordance with the present invention consider derivatives as part of the portfolio.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 is a block diagram of an example of a system in accordance with a preferred embodiment of the present invention implemented on a personal computer.

FIG. 2 is a block diagram of an example of a system in accordance with an alternative embodiment of the present invention implemented on a personal computer coupled to a web or Internet server.

FIG. 3 is a flowchart illustrating a method in accordance with a preferred example of the present invention for providing large-scale portfolio optimization with factor models of asset returns.

### DETAILED DESCRIPTION OF THE PREFERRED EMBODIMENTS

The present invention is particularly applicable to a computer implemented software based financial asset portfolio management system for providing large-scale portfolio optimization, and it is in this context that the various embodiments of the present invention will be described. It will be appreciated, however, that the system and method for providing general portfolio optimization, including mean-variance optimization, expected utility maximization, and mean-risk optimization in large-scale portfolio management in accordance with the present invention have greater utility, since they may be implemented in hardware or may incorporate other modules or functionality not described herein.

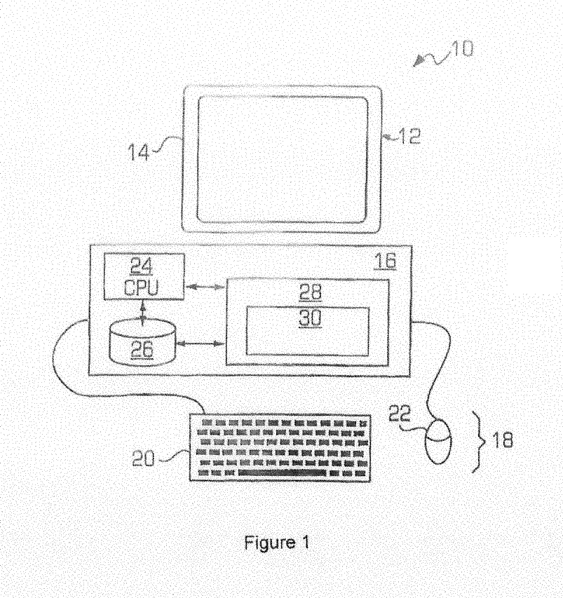

FIG. 1 is a block diagram illustrating an example of a general portfolio, management system 10 for large-scale portfolio optimization in accordance with one embodiment of the present invention implemented on a personal computer 12. In particular, the personal computer 12 may include a display unit 14, which may be a cathode ray tube (CRT), a liquid crystal display, or the like; a processing unit 16; and one or more input/output devices 18 that permit a user to interact with the software application being executed by the personal computer. In the illustrated example, the input/output devices 18 may include a keyboard 20 and a mouse 22, but may also include other peripheral devices, such as printers, scanners, and the like. The processing unit 16 may further include a central processing unit (CPU) 24, a persistent storage device 26, such as a hard disk, a tape drive, an optical disk system, a removable disk system, or the like, and a memory 28. The CPU 24 may control the persistent storage device 26 and memory M. Typically, a software application may be permanently stored in the persistent storage device 26 and then may be loaded into the memory 28 when the software application is to be executed by the CPU 24. In the example shown, the memory 28 may contain a large-scale portfolio optimization tool 30 for portfolio management. The portfolio optimization tool 30 may be implemented as one or more software modules that are executed by the CPU 24. In accordance with various contemplated embodiments of the present invention, the general portfolio management system 10 may also be implemented using hardware and may be implemented on different types of computer systems, such as client/server systems, Web servers, mainframe computers, workstations, and the like.

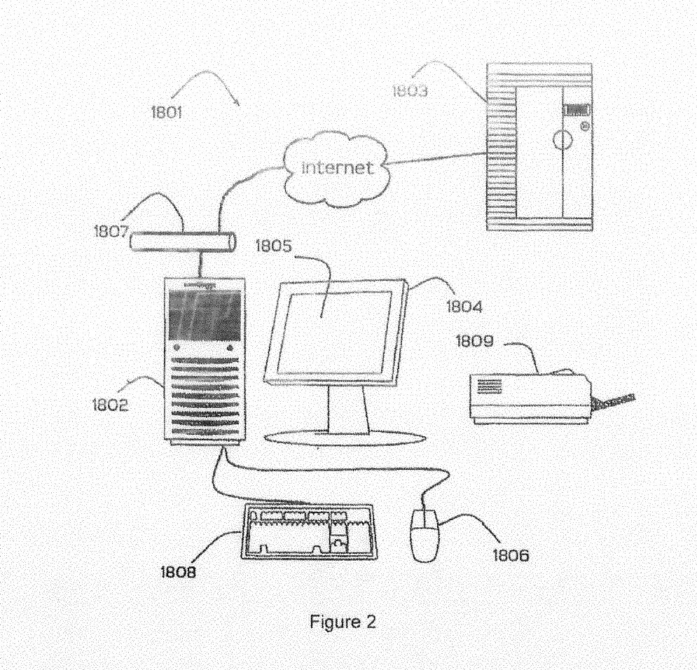

Thus, in accordance with another embodiment of the present invention, the general portfolio optimization system 10 is implemented via a hosted Web server. A system using a hosted Web server, generally indicated by the numeral 1801, is shown in FIG. 2. The system 1801 preferably comprises a Web-based application accessed by a personal computer 1802, as shown in FIG. 2. For example, the personal computer 1802 may be any personal computer having at least two gigabytes of random access memory (RAM), using a Web browser, preferably MICROSOFT Internet Explorer 6.0 browser or greater. In this example, the system 1801 is a 128-bit SSL encrypted secure application running on a MICROSOFT Windows Server 2003 operating system or Windows Server 2000 operating system or later operating system available from Microsoft Corporation located in Redmond, Wash. The personal computer 1802 also, comprises a hard disk drive preferably having at least 40 gigabytes of free storage space available. The personal computer 1802 is coupled to a network 1807. For example, the network 1807 may be implemented using an Internet connection. In one implementation of the system 1801, the personal computer 1802 can be ported to the Internet or Web, and hosted by a server 1803. The network 1807 may be implemented using a broadband data connection, such as, for example, a DSL or greater connection, and is preferably a Tl or faster connection. The graphical user interface of the system 1801 is preferably displayed on a monitor 1804 connected to the personal computer 1802. The monitor 1804 comprises a screen 1805 for displaying the graphical user interface provided by the system 1801. The monitor 1804 may be a 15 color monitor and is preferably a 1024×768, 24-bit (16 million colors) VGA monitor or better. The personal computer 1802 further comprises a 256 or more color graphics video card installed in the personal computer. As shown in FIG. 2, a mouse 1806 is provided for mouse-driven navigation between screens or windows comprising the graphical user interface of the system 1801. The personal computer 1802 is also preferably connected to a keyboard 1808. The mouse 1806 and keyboard 1808 enable a user utilizing the system 1801 to perform general portfolio management. Preferably, the user can print the results using a printer 1809. The system 1801 is implemented as a Web-based application, and data may be shared with additional software (e.g., a word processor, spreadsheet, or any other application). Persons skilled in the art will appreciate that the systems and techniques described herein are applicable to a wide array of business and personal applications.

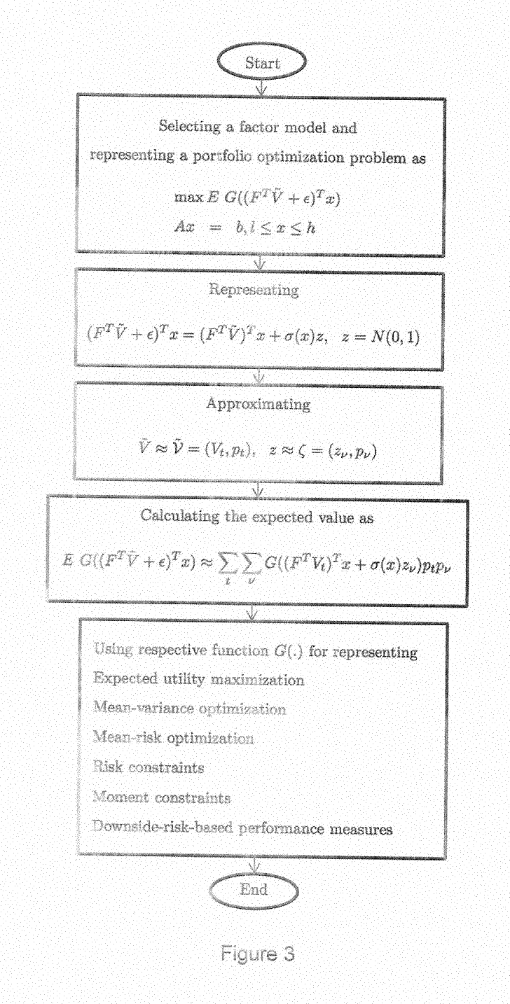

In accordance with a preferred example of the method of the present invention shown in FIG. 3 to manage a portfolio of financial assets to provide large-scale portfolio optimization, including mean-variance optimization, expected utility maximization, and general mean-risk portfolio optimization, the representation of asset returns is presented via a factor model.

Asset Returns

Factor models have been introduced that linearly relate at each period t≥1 the n-vector of asset returns \tilde{R}ₜ to the values (or change in values) of a smaller number k of factors, \tilde{V}ₜ. The factor model representation of the asset returns has many desirable properties, including that it has good explanatory power and the resulting covariance matrix of asset returns is of full rank. It has also theoretical importance, as modern asset pricing theories have factor models as their underpinnings, e.g., the capital asset pricing model (CAPM); see William F. Sharpe, Capital asset prices: A theory of market equilibrium under conditions of risk, Journal of Finance, 19(3): pages 425-442, 1964 and John Liirtner, The valuation of risk assets and the selection of risky investments in stock portfolios and capital budgets, Review of Economics and Statistics, 47(1): pages 13-37, 1965; and the arbitrage pricing theory (APT); see Stephen A. Ross, The arbitrage theory of capital asset pricing; Journal of Economic Theory, 13 (3), pages 341-360, provide equilibrium prices and returns for assets traded in the markets.

Suppose asset returns in each period t≥1 follow a factor model,

\tilde{R}ₜ=\tilde{F}ₜ^{T}\tilde{V}ₜ+\tilde{ε}ₜ

where \tilde{F}ₜ is the k×n random matrix of factor loadings, \tilde{V}ₜ is the random k-vector of the values of the factors (sometimes also called factor returns), and \tilde{ε}ₜ is the random n-vector of idiosyncratic returns. The formulation includes a mean (or intercept) vector, if we define the (random) value of the first factor as having always the value 1, thus, the random returns for each asset i are represented as

\tilde{R}ᵢₜ=\tilde{F}₁ᵢₜ+\tilde{F}₂ᵢₜ\tilde{V}₂ₜ+ . . . +\tilde{F}ₖᵢₜ\tilde{V}ₖₜ+\tilde{ε}ᵢₜ.

We assume that the idiosyncratic returns \tilde{ε}ₜ are multi-variate normally distributed, \tilde{ε}=N(0, Σₜ), where the covariance Σₜ=diag(σᵢₜ²), and \tilde{ε}ₜ is assumed independently distributed, between its components, respectively, and independently distributed with respect to \tilde{V}ₜ. (A factor model may also be defined for asset risk premia, i.e., excess returns over the risk-free rate, and the risk-free rate may be added to the asset risk premia to obtain asset returns.)

Underlying the factor model of asset returns may be two different statistical models of asset returns:

Statistical model (1): Let \tilde{F}ₜ=F be constant. Let \tilde{V}ₜ, t≥1 and \tilde{ε}ₜ, t≥1 be each independently and identically distributed random variables. Then \tilde{R}ₜ=F^{T} \tilde{V}ₜ+\tilde{ε}ₜ, t≥1 is an independently and identically distributed random variable. We observe at each period t=1, . . . T an outcome Rₜ, Vₜ, and εₜ of \tilde{R}ₜ, \tilde{V}ₜ, and \tilde{ε}ₜ, respectively. At period T+1, the current period at which a portfolio decision is to be made, we write the random vector of asset returns as

\tilde{R}_{T+1}|\tilde{R}1, . . . ,\tilde{R}T=F^{T}\tilde{V}_{T+1}|\tilde{V}1, . . . ,\tilde{V}T+\tilde{ε}_{T+1}|\tilde{ε}1, . . . ,\tilde{ε}T.

But based on independence, \tilde{R}_{T+1}=\tilde{R}_{T+1}|\tilde{R}₁, . . . , \tilde{R}_{T}, \tilde{V}_{T+1}=\tilde{V}_{T+1}|\tilde{V}₁, . . . , \tilde{V}_{T} and \tilde{ε}_{T+1}=\tilde{ε}_{T-1}|\tilde{ε}₁, . . . , \tilde{ε}_{T}, thus,

\tilde{R}_{T+1}=F^{T}\tilde{V}_{T+1}+\tilde{ε}_{T+1},

which we may write as

\tilde{R}=F^{T}\tilde{V}+\tilde{ε}

by setting \tilde{R}≡\tilde{R}_{T-1}, \tilde{V}≡\tilde{V}_{T+1}, and \tilde{ε}≡\tilde{ε}_{T+1}, thereby suppressing the time index for period T+1. Accordingly, \tilde{ε}=N(0, Σ), where Σ=diag(σᵢ²).

Statistical model (1) is applicable to macro-economic factor models. The factors in this framework may be macro-economic variables that influence asset returns, such as (changes in) gross domestic product, oil prices, unemployment rate, interest rates, etc., and the factor loadings of an asset represent its exposure to each of the macro-economic factors.

Extensions of the model include possible time dependency of \tilde{V}ₜ and/or \tilde{ε}ₜ, by defining the conditional distributions \tilde{R}_{T+1}|\tilde{R}₁, . . . , \tilde{R}_{T}, \tilde{V}_{T+1}|\tilde{V}₁, . . . , \tilde{V}_{T} and/or \tilde{ε}_{T+1}|\tilde{ε}₁, . . . , \tilde{ε}_{T}. For example, considering \tilde{V}_{T+1}|\tilde{V}₁, . . . , \tilde{V}_{T} includes time-series models of the factors such as vector autoregressive processes and considering \tilde{ε}_{T+1}|\tilde{ε}₁, . . . , \tilde{ε}_{T} includes models with time-varying idiosyncratic variances, i.e., GARCH processes.

Statistical model (2): Let \tilde{F}ₜ, t≥1 be a sequence of independently and identically distributed random variables. Conditional on \tilde{F}ₜ, let \tilde{V}ₜ and \tilde{ε}ₜ, t≥1 be each independently and identically distributed random variables. Then, \tilde{R}ₜ|\tilde{F}ₜ=\tilde{F}ₜ^{T}\tilde{V}ₜ|\tilde{F}ₜ+\tilde{ε}ₜ|\tilde{F}ₜ is an independently and identically distributed random variable. We observe at each period t=1, . . . T an outcome Rₜ, Vₜ, Fₜ, and εₜ of \tilde{R}ₜ, \tilde{V}ₜ, \tilde{F}ₜ, and \tilde{ε}ₜ, respectively and at the current period T+1. at which a portfolio decision is to be made, an outcome Fₜ of \tilde{F}ₜ. At the current period T÷1 we write the random vector of asset returns as

\tilde{R}_{T+1}|\tilde{R}₁,\tilde{F}₁, . . . ,\tilde{R}_{T},\tilde{F}_{T},\tilde{F}_{T+1}=\tilde{F}_{T÷1}\tilde{V}_{T+1}|\tilde{V}₁,\tilde{ε}₁, . . . ,\tilde{V}_{T},\tilde{F}_{T},\tilde{F}_{T+1}+\tilde{ε}_{T+1}|\tilde{ε}₁,\tilde{F}₁, . . . ,\tilde{ε}_{T},\tilde{F}_{T},\tilde{F}_{T+1}.

Based on independence,

\tilde{R}_{T÷1}|\tilde{F}_{T+1}=\tilde{R}_{T+1}|\tilde{R}₁,\tilde{F}₁, . . . ,\tilde{R}_{T}\tilde{F}_{T},\tilde{F}_{T+1},

V_{T+1}|\tilde{F}_{T+1}=\tilde{V}_{T+1}|\tilde{V}₁,\tilde{F}₁, . . . ,\tilde{V}_{T},\tilde{F}_{T},\tilde{F}_{T+1}

and

\tilde{ε}_{T÷1}|\tilde{F}_{T+1}=\tilde{ε}_{T+1}|\tilde{ε}₁,\tilde{F}₁, . . . ,\tilde{ε}_{T},\tilde{F}_{T},\tilde{F}_{T+1},

thus,

\tilde{R}_{T+1}|\tilde{F}_{T+1}=\tilde{F}_{T+1}^{T}\tilde{V}_{T+1}|\tilde{F}_{T+1}+\tilde{ε}_{T+1}|\tilde{F}_{T+1}.

Since at period T+1, an outcome F_{T+1} of \tilde{F}_{T+1} is observed, we may write

\tilde{R}=F^{T}\tilde{V}+\tilde{ε}

by setting \tilde{R}≡\tilde{R}_{T+1}|\tilde{F}_{T+1}=F_{T+1}, \tilde{V}≡\tilde{V}_{T+1}|\tilde{F}_{T+1}=F_{T+1}, \tilde{ε}≡\tilde{ε}_{T+1}|\tilde{F}_{T+1}=F_{T+1}, and F≡F_{T÷1}, thereby suppressing the time index T+1 and the dependency on the observed value F_{T+1} of \tilde{F}_{T÷1}. Accordingly, \tilde{ε}=N(0, Σ), where Σ=diag(σᵢ²).

Statistical model (2) is applicable to fundamental factor models, where factor loadings may be asset-specific fundamental quantities, say, data derived from accounting statements, such as earnings (over price ratio), dividend yield, past performance, etc., and a factor may be defined as the return of a (long-short) portfolio that has an exposure of one to a specific factor loading and a zero exposure to all other factor loadings considered in the factor model. Extensions of the model include possible time dependency of \tilde{V}_{T+1} and/or \tilde{ε}_{T÷1}, by, defining the conditional distributions \tilde{R}≡\tilde{R}_{T+1}|\tilde{R}₁, \tilde{F}₁, . . . , \tilde{R}_{T}, \tilde{F}_{T}, \tilde{F}_{T+1}, \tilde{V}≡\tilde{V}_{T+1}|\tilde{V}₁, \tilde{F}₁, . . . , \tilde{V}_{T}, \tilde{F}_{T}, \tilde{F}_{T+1} and/or \tilde{ε}≡\tilde{ε}_{T+1}|\tilde{ε}₁, \tilde{F}₁, . . . , \tilde{ε}_{T}, \tilde{F}_{T}, \tilde{F}_{T+1}. For example, defining \tilde{V}_{T+1}|\tilde{V}₁, \tilde{F}₁, . . . , \tilde{V}_{T}, \tilde{F}_{T}, \tilde{F}_{T+1} would allow for time-series models of the factors and/or defining \tilde{ε}_{T+1}|\tilde{ε}₁, \tilde{F}₁, . . . , \tilde{ε}_{T}, \tilde{F}_{T}, \tilde{F}_{T+1} would allow for models with time-varying idiosyncratic variances, i.e., GARCH processes.

The factor model representation \tilde{R}=F^{T}\tilde{V}+\tilde{ε}, based on statistical models (1) and (2), covers a wide range of factor models that have been developed for representing asset returns in practical situations.

In any portfolio optimization problem, one needs to maximize the expected value of a function of the portfolio return, say, max EG(\tilde{R}^{T}x). In mean-variance portfolio optimization this would result in max

$$E {\tilde{R}}^{T} x - \frac{γ}{2} var ( {\tilde{R}}^{T} x ) ,$$

in utility maximization max Eu(1+\tilde{R}^{T}x), and in mean-risk optimization max

$$E {\tilde{R}}^{T} x - \frac{γ}{2} Risk ( {\tilde{R}}^{T} x ) .$$

For asset returns following a factor model,

EG(\tilde{R}^{T}x)=EG((F^{T}\tilde{V}+\tilde{ε})^{T}x)

and calculating this expectation, without taking advantage of any special structure, involves multiple integration:

$$EG ( {\tilde{R}}^{T} x ) = {\int }_{- ∞}^{+ ∞} {\int }_{- ∞}^{+ ∞} … {\int }_{- ∞}^{+ ∞} G ( {( {F}^{T} \tilde{V} )}^{T} x + {\sum }_{i} {σ}_{i} {x}_{i} {z}_{i} ) dP ( \tilde{V} ) {p}_{1} ( {z}_{1} ) … {p}_{n} ( {z}_{n} ) {dz}_{1 } … {dz}_{n} ,$$

where P(\tilde{V}) is the cumulative distribution function of the factors \tilde{V} and where zᵢ=N(0,1) is an independent unit normal distribution with density function

$${p}_{i} ( {z}_{i} ) = \frac{1}{\sqrt{2 π}} {e}^{- {z}_{i}^{2} / 2} ,$$

for each asset i=1, . . . , n. In this formulation, portfolio returns are a linear function of the portfolio weights x.

In order to maximize EG(\tilde{R}^{T}x) one needs function evaluations and gradients as a function of the portfolio weights x or at any given value of x.

For a given portfolio with weights x, the factor model returns of a portfolio,

\tilde{R}_{T}x=(F^{T}x\tilde{V}+\tilde{ε})^{T}x=(F^{T}\tilde{V})^{T}x+\tilde{ε}^{T}x,

may be expressed as

\tilde{R}^{T}x=(F^{T}\tilde{V})^{T}x+σ(x)z,

based on the assumption that the idiosyncratic returns are each independently normally distributed, from which

$$σ ( x ) = \sqrt{{x}^{T} Σ x} = \sqrt{{\sum }_{i = 1}^{n} {σ}_{i}^{2} {x}_{i}^{2}}$$

$$and$$

$$z = N ( 0 , 1 )$$

is a one dimensional unit normal distribution. Thus,

EG(\tilde{R}^{T}x)=∫_{-∞}^{+∞}∫_{-∞}^{+∞}G((F^{T}\tilde{V})^{T}x+σ(x)z)dP(\tilde{V})p(z)dz,

where

$$p ( z ) = \frac{1}{\sqrt{2 π}} {e}^{- {z}^{2} / 2}$$

is the density of the unit normal distrubution.

With this reformulation, portfolio returns (F^{T}\tilde{V})^{T}x+σ(x)z are a nonlinear function of the portfolio variables x, since they depend on σ(x). The function \sqrt{x^{T}Σx} is convex with respect to the portfolio variables x, since compound functions of the type

$${( {\sum }_{i} {{g}_{i} ( x )}^{q} )}^{\frac{1}{q}}$$

are convex for convex and nonnegative functions gᵢ(x); see, e.g., S. P. Boyd and L. Vandenberghe, Convex Optimization, Cambridge University Press, Cambridge, UK, 2004. In this context, gᵢ(x)=\sqrt{σᵢ²xᵢ²} is convex (linear) in x and nonnegative.

The expectation

EG(\tilde{R}^{T}x)=∫_{-∞}^{+∞}∫_{-∞}^{+∞}G((F^{T}\tilde{V})^{T}x+σ(x)z)dP(\tilde{V})p(z)dz,

is exactly the same as the linear form in x introduced above:

$$EG ( {\tilde{R}}^{T} x ) = {\int }_{- ∞}^{+ ∞} {\int }_{- ∞}^{+ ∞} … {\int }_{- ∞}^{+ ∞} G ( {( {F}^{T} \tilde{V} )}^{T} x + {\sum }_{i} {σ}_{i} {x}_{i} {z}_{i} ) dP ( \tilde{V} ) {p}_{1} ( {z}_{1} ) … {p}_{n} ( {z}_{n} ) {dz}_{1 } … {dz}_{n} ,$$

for any value of x. If two functions with respect to x have the same function value for any value of x, then they are the same function, irrespective of their inner workings. Thus, if one function is concave (convex) in x so is the other. From the latter expression for EG(\tilde{R}^{T}x) it follows that EG(\tilde{R}^{T}x) is concave (convex) if the function GO is a concave (convex) function in its argument. This is the case, because compound functions G(h(x)) are concave (convex) if G(·) is concave (convex) and h(x) is linear in x, and because the expectation of a concave (convex) function in x with respect to a random variable is a concave (convex) function in x; see, e.g., S. P. Boyd and L. Vandenberghe, Convex Optimization, Cambridge University Press, Cambridge, UK, 2004. Thus, we proved that

EG(\tilde{R}^{T}x)=∫_{-∞}^{+∞}∫_{-∞}^{+∞}G((F^{T}\tilde{V})^{T}x+σ(x)z)dP(\tilde{V})p(z)dz,

is a concave (convex) function with respect to x, if G(·) is a concave (convex) function in its argument.

This is not obvious, since, as stated above, (F^{T}\tilde{V})^{T}x+σ(x)z is not concave (convex) with respect to x, because σ(x)z is convex for outcomes z>0 and concave for outcomes z<0. Thus, G((F^{T}\tilde{V})^{T}x+σ(x)z) is not necessarily concave (convex) with respect to x, even if G(·) is concave (convex) in its argument; but it may be, depending on how strongly concave (convex) G(·) is. For the convex risk measures discussed herein we have empirically observed that G((F^{T}\tilde{V})^{T}x+σ(x)z) (defined as the negative of Risk(\tilde{R}^{T}x)) is typically concave in x, but for expected utility maximization with a very low risk aversion parameter, where G(·) is almost linear in its argument, G((F^{T}\tilde{V})^{T}x+σ(x)z) may not be concave in x. This demonstrates that the expectation of a non concave (non convex) function can be a concave (convex) function.

We now approximate the unit normal random variable z by a discrete random variable

ζ=(zᵥ,pᵥ)

with realizations zᵥ occurring with probability pᵥ, for v=1, . . . , m. That is, the continuous unit normal distribution is represented by a histogram with the properties that its mean is zero, E(ζ)=0, its variance is approximately one, E(ζ²)≈1, and its higher moments match those of the unit normal distribution. For a sufficiently large number of discrete outcomes, the discrete representation closely approximates the unit normal distribution, i.e.,

$${lim}_{m \to ∞} {max}_{z} \vert ( z ) - Q ( z ) \vert = 0 ,$$

and the cumulative distribution function of the discrete approximation [symbol] (z) would match closely the cumulative distribution function Q(z) of the unit normal distribution.

A discrete approximation of the unit normal distribution, obtained using optimization, is given in Table 1. It is preferably based on 51 equally spaced points between −5 and +5 and very closely matches the unit normal distribution. For practical Purposes this seems sufficiently accurate, since the tail area of

$$\frac{1}{\sqrt{2 π}} {\int }_{- ∞}^{- 5} {ze}^{- \frac{{z}^{2}}{2}} dz = 2.8665 e - 07$$

of probability mass is all that is not captured on either side of the unit normal distribution. (Using 6 standard deviations, the one sided error would be 9.8659e-10.) Its first 8 moments are: mean=0.000000, variance=1.000000, skewness=0.000000, kurtosis=3.000000, m₅=0.000000, m₆=15.000000, m₇=0.000000, m₈=105.000000.

Using the discrete approximation ζ of the unit normal random variable, we may express the returns of a portfolio generated by the factor model for any outcome zᵥ of ζ as

\tilde{R}ᵥ(x)=(F^{T}\tilde{V})^{T}x+σ(x)zᵥ,

and compute expectations as

$$EG ( {\tilde{R}}_{v} ( x ) ) = {\int }_{- ∞}^{+ ∞} {\sum }_{v} G ( {( {F}^{T} \tilde{V} )}^{T} x + σ ( x ) {z}_{v} ) {p}_{v} dP ( \tilde{V} ) .$$

The multi-variate distribution \tilde{V}, may have different forms depending on the factors used. It may exhibit fat tails and may be peaky. The statistics of the population of \tilde{V} are typically not known and thus a parametric representation appears difficult. Instead, we proceed non-parametrically. Since \tilde{V}ₜ, t=1, . . . , T+1, are assumed independently and identically distributed, observed outcomes Vₜ at periods t=1, . . . , T are also observed outcomes of \tilde{V}≡\tilde{V}_{T+1}. Let \tilde{V} be a random variable defined by the empirically observed outcomes Vₜ with corresponding, probability

$${p}_{t} = \frac{1}{T} .$$

Using \tilde{V}, we obtain an entirely discrete representation of the factor model returns as

Rₜᵥ(x)=(F^{T}Vₜ)^{T}x+σ(x)zᵥ

with associated probabilities pₜᵥ=pₜpᵥ. Defining a new discrete random vector [symbol] (x)=(Rₜᵥ(x),pₜᵥ), with outcomes Rₜᵥ(x) and associated probability pₜᵥ, and using the sample-average approximation, using \tilde{V}, we calculate the conditional expectation, given ζ=zᵥ, as

$$EG ( {\tilde{R}}_{v} ( x ) ) \vert ζ = {\sum }_{t} G ( {( {F}^{T} {V}_{t} )}^{T} x + σ ( x ) {z}_{v} ) {p}_{t} ,$$

where

$${p}_{t} = \frac{1}{T} .$$

For sufficiently large number T of observations Vₜ, EG [symbol] (x))|ζ closely approximates EG(\tilde{R}ᵥ(x))|ζ, as EG( [symbol] (x))|ζ→EG(\tilde{R}ᵥ(x))|ζ as T→∞.

Now we can calculate the expectation EG( [symbol] (x)) entirely as a multiple sum:

$$EG ( \tilde{R} ( x ) ) = {\sum }_{t} {\sum }_{v} G ( {( {F}^{T} {V}_{t} )}^{T} x + σ ( x ) {z}_{v} ) {p}_{t} {p}_{v} ,$$

and EG( [symbol] (x)) closely approximates EG(\tilde{R}(x)), as EG( [symbol] (x))→EG(\tilde{R}(x)) as T→∞ and as ζ closely approximates z.

We, thus, have, for a general factor model representation of asset returns expressed portfolio returns as a function of x as a random variable with a discrete distribution. We call this approach semi-parametric approximation, since the idiosyncratic component of the asset returns is represented parametrically and the factor explained component is represented non-parametrically. Any expectation of functions of portfolio returns that may occur in a portfolio optimization model can therefore, be computed by multiple sums (over t and v), making portfolio optimization problems very tractable and amenable to solution. We have shown above that EG(\tilde{R}^{T}x) is concave (convex) in x if G(·) is concave (convex) in its argument, therefore portfolio optimization problems based on our reformulation are convex problems that can be solved with (convex) nonlinear programming techniques and any local optimum is also a global optimum.

In practice, the true parameters of the distributions \tilde{R}, \tilde{V}, and \tilde{ε} are unknown and need to be estimated. We obtain estimates of these unknown true quantities by actually estimating a factor model, based on the statistical models introduced above. There are three types of factor models generally in use: the macro-economic (see, e.g., Roll A. Chen, N. F. and S. A. Ross: Economic forces and the stock market, The Journal of Business, 59 (3): 383-404, 1986, the statistical and the fundamental factor model, see, e.g., B. A. Rosenberg: Extra-market components of covariance in security returns, Journal of Financial and Quantitative Analysis, 9 (2): 263-273, 1974. Macro-economic and statistical factor models are estimated based on statistical model (1) and fundamental factor models are estimated based on statistical model (2). See G. Connor: The three types of factor models: A comparison of their explanatory power, Financial Analysts Journal, 51 (3): 42-46, 1995, about the explanatory power of the three types of factor models. There are also hybrid models as a suitable combination of the three factor models. A related approach, includes E. F. Fama and K. R. French: The cross-section of expected stock returns, Journal of Finance, 47 (2): 427-465, 1992, and E. F. Fama and K. R. French: Common risk factors in the returns on stocks and bonds, Journal of Financial Economics, 33: 3-56, 1993, where factors are defined as returns of so called factor-mimicking portfolios. For the estimation of factor models, see also E. F. Fama and J. D. MacBeth: Risk, return, and equilibrium: Empirical tests, The Journal of Political Economy, 81 (3): 607-636, 1973.

In the following the discrete representation of the factor returns is applied to expected utility optimization, mean-variance optimization, and general mean-risk optimization to formulate and study the resulting models. By doing so we develop a semi-parametric approach for modeling and solving general types portfolio optimization problems.

It is useful to partition the factor explained returns F^{T}\tilde{V} into a demeaned part F^{T}\tilde{V}₀ and its mean vector μ=F^{T}E\tilde{V}, where \tilde{V}=μ+\tilde{V}₀. With this partition, the factor-explained returns are \tilde{R}_{F}=μ+F^{T}\tilde{V}₀ and the factor model returns may be expressed as \tilde{R}=μ+F^{T}\tilde{V}+\tilde{ε}. Accordingly, we denote observed outcomes of \tilde{V}₀ as V₀ₜ and observed outcomes of \tilde{R}_{F} as \tilde{R}_{Ft}.

Expected Utility Maximization

It is desirable to use the factor model also for expected utility optimization. The corresponding portfolio optimization problem is stated as

max E u(1+(F^{T}\tilde{V}+\tilde{ε})^{T}x)

Ax=b,l≤x≤h

We note that the objective function includes the expectation over the random vector (F^{T}\tilde{V}) and over the continuous n-dimensional random vector \tilde{ε}. This is why this problem is considered to be difficult.

Expected utility maximization problems have been put forward using a sample-average approximation based on historical return observations in R. C. Grinold, Mean-variance and scenario-based approaches to portfolio selection, Journal of Portfolio Management, 25(2), pages 10-22, 1999:

$$max \frac{1}{T} {\sum }_{t} u ( I + {R}_{t}^{T} x )$$

$$Ax = b , l \leq x \leq h$$

TABLE 1
Discrete representation of the unit normal distribution

| zᵥ | zᵥ | pᵥ |
|---|---|---|
| −5.0000 | 5.0000 | 0.000000536685270 |
| −4.8000 | 4.8000 | 0.000000849689232 |
| −4.6000 | 4.6000 | 0.000001845241790 |
| −4.4000 | 4.4000 | 0.000004525164464 |
| −4.2000 | 4.2000 | 0.000010663489269 |
| −4.0000 | 4.0000 | 0.000028325893333 |
| −3.8000 | 3.8000 | 0.000061546829887 |
| −3.6000 | 3.6000 | 0.000124946943306 |
| −3.4000 | 3.4000 | 0.000246546756629 |
| −3.2000 | 3.2000 | 0.000473614054347 |
| −3.0000 | 3.0000 | 0.000880247095147 |
| −2.8000 | 2.8000 | 0.001575730929924 |
| −2.6000 | 2.6000 | 0.002710675043685 |
| −2.4000 | 2.4000 | 0.004477252136737 |
| −2.2000 | 2.2000 | 0.007099906873363 |
| −2.0000 | 2.0000 | 0.010810776888386 |
| −1.8000 | 1.8000 | 0.015808766582307 |
| −1.6000 | 1.6000 | 0.022204750725027 |
| −1.4000 | 1.4000 | 0.029961198684615 |
| −1.2000 | 1.2000 | 0.038839350894021 |
| −1.0000 | 1.0000 | 0.048374186883117 |
| −0.8000 | 0.8000 | 0.057889903396360 |
| −0.6000 | 0.6000 | 0.066565812031542 |
| −0.4000 | 0.4000 | 0.073547303686698 |
| −0.2000 | 0.2000 | 0.078082629138417 |
| 0.0000 | 0.0000 | 0.079655674554058 |

where the return observations Rₜ are calibrated to reflect forward-looking estimates of mean return and volatility. The sample average model is a good approximation as long as T>>n, since only then is the problem of full rank and statistically viable. For large-scale utility maximization problems, arising in equities, where n>T, the sample average approximation based on historical return observations is not a satisfactory approximation.

A more promising approach may be to use sampling from the factor model representation of asset returns. Also in this case, in order to represent the distribution of asset returns accurately and to obtain a problem of full rank, the sample size needs to be very large, i.e., T>>n. However, this may be computationally prohibitive for a large number of assets.

Approximations to related versions of the expected utility maximization problem based on a factor model of asset returns have been put forward by M. W. Brandt, P. Santa Clara, and R. Valkanov, Parametric portfolio policies: Exploiting characteristics in the cross section of equity returns, Review of Financial Studies, 22(9), pages 3411-3447, 2004, and by S. De Boer, Factor tilting for expected utility maximization, Journal of Asset Management 11, pages 31-42, 2010. M. W. Brandt et al. built an expected utility maximization model with factor exposures as the decision variables, and the portfolio weights were subsequently derived from the estimated factor loadings and the optimal factor exposures. This model assumes constant factor exposures over time. S. De Boer calculates first the expected utility optimal portfolio weights for a given factor exposure parametrically as a function of possible factor exposures, and then solves the expected utility optimization problem in the factor space. Both methods are, approximations and appear unable to handle general constraints.

We proceed differently and, using the semi-parametric approach, formulate and solve the expected utility optimization problem directly:

maxΣₜΣᵥu(1+R_{Ft}^{T}x+σ(x)z_{w})pₜpᵥ

Ax=b,l≤x≤h,

where σ(x)=\sqrt{x^{T}Σx}. This is a discrete formulation with T*m realizations representing accurately the factor model returns, where for each outcome t there are m outcomes representing the unit normal distribution multiplied by the nonlinear term σ(x). Like the original expected utility maximization problem, this reformulated expected utility maximization problem is a convex problem for concave utility functions u(·).

Gradients with respect to the decision variables x are obtained as

$$\frac{\partial }{\partial {x}_{i}} {\sum }_{t} {\sum }_{v} u ( 1 + {R}_{Ft}^{T} x + σ ( x ) {z}_{v} ) {p}_{t} {p}_{v} = {\sum }_{t} {\sum }_{v} {u}^{′} ( 1 + {R}_{Ft}^{T} x + σ ( x ) {z}_{v} ) ( {R}_{Fi} + \frac{1}{σ ( x )} {σ}_{i}^{2} {x}_{i} {z}_{v} ) {p}_{t} {p}_{v}$$

with σ(x)=\sqrt{x^{T}Σx}. The expected utility maximization problem is then solved using a gradient-based nonlinear optimization algorithm; see for example, MINOS, B. A. Murtagh and M. A. Saunders, Minos user's guide, Technical Report SOL 83-20, Department of Operations Research, Stanford University, Stanford Calif. 94305, 1983.

Thus, we formulated the expected utility maximization problem as a nonlinear optimization problem with linear constraints. It is a convex problem if u(·) is concave.

Calibrating the Expected Utility Model to a Benchmark

Equilibrium returns can be obtained from the expected utility maximization model.

We write the vector of mean returns, μ=F^{T}E\tilde{V}, predicted by the factor model, as the sum of two components, an unconditional part, equilibrium returns implied by the market, and a conditional (on the factor model) part:

μ=μₑ+μₑ,

where μₑ is the vector of the unconditional equilibrium mean asset returns and μ_{c} is the vector of the conditional part of mean asset returns, conditioned on the factor model used. For convenience, we define as

\tilde{η}ₜ=F^{T}\tilde{V}₀ₜ,

the demeaned factor-explained return.

Thus, the factor model returns may be written as:

\tilde{R}=μ_{c}+μₑ+\tilde{η}ₜ+\tilde{ε}

and its demeaned part as

\tilde{R}ᵤ=μₑ+\tilde{η}ₜ+\tilde{ε}.

The goal in calibration is to determine an unconditional mean vector μₑ such that the expected utility maximization problem

max E u(1+(μₑ+\tilde{η}ₜ+\tilde{ε})^{T}x)

e^{T}x=1

for u=u_{B} results in the benchmark portfolio x₃. The benchmark weights x_{B} are considered as representative of the weights of the market portfolio. Thus, the equilibrium weights x_{B} imply unconditional expected returns μₑ. The optimization problem includes only e^{T}x=1 as a constraint, and also no bounds on holdings are needed since constraints and bounds are not relevant for the benchmark portfolio.

The market equilibrium approach has been introduced for a mean-variance based market equilibrium by F. Black and R. Litterman, Global portfolio optimization, Financial Analysts Journal, 48(5), pages 28-43, 1992, and extended for a scenario-based utility maximization equilibrium by R. C. Grinold, Mean-variance and scenario-based approaches to portfolio selection, Journal of Portfolio Management, 25(2), pages 10-22, 1999. We now present an equilibrium model for expected utility optimization when returns follow a factor model.

The Lagrangian function is

L(x,λ)=E u(1+\tilde{R}ᵤ^{T}x)+λ(1−e^{T}x)

and the optimality conditions are

$$\frac{\partial L ( x , λ )}{\partial x} = {Eu}^{′} ( 1 + {\tilde{R}}_{u}^{T} x ) {R}_{u} - λ e = 0$$

$$and$$

$$\frac{\partial L ( x , λ )}{\partial λ} = 1 - {e}^{T} x = 0 ,$$

where \tilde{R}ᵤ=μₑ+\tilde{η}ₜ+\tilde{ε}.

For x=x_{B} and u=u_{B} (say, for the power utility function, γ=γ_{B})

E u′_{B}(1+ᵤ^{T}x_{B})\tilde{R}ᵤ−λe=0

Multiplying by x_{B}^{T} on the left, one obtains

E u′_{B}(1+\tilde{R}ᵤ^{T}x_{B})\tilde{R}_{uB}−λ=0,

by setting \tilde{R}_{uB}=x^{T}D\tilde{R}ᵤ, the unconditional return of the benchmark, and noting that x_{B}^{T}e=1. Thus,

λ=E u′_{B}(1+\tilde{R}_{uB})\tilde{R}_{uB},

Substituting for λ, one obtains for each i=1, . . . , n:

E u′_{B}(1+\tilde{R}_{uB})\tilde{R}_{u,i}−E u′_{B}(1+\tilde{R}_{uB}B)\tilde{R}_{uB}=0.

Expanding \tilde{R}ᵤ, denoting μ_{B}=μₑ^{T}x_{B}, \tilde{η}_{Bt}=\tilde{η}ₜ^{T}x_{B}, and \tilde{ε}_{B}=\tilde{ε}^{T}x_{B}, one obtains for i=1 . . . , n:

E u′_{B}(1+\tilde{R}_{uB})μₑᵢ+E u′_{B}(1+\tilde{R}_{uB})(\tilde{η}ₜᵢ+\tilde{ε}ᵢ)−E u′_{B}(1+\tilde{R}_{uB})μ_{B}−Eu′_{B}(1+\tilde{R}_{uB})(\tilde{η}_{Bt}+\tilde{ε}_{B})=0.

Thus, one obtains for a given value of μ_{B}:

$${μ}_{ei} - {μ}_{B} = - \frac{E {u}_{B}^{′} ( 1 + {\tilde{R}}_{uB} ) ( {\tilde{η}}_{ti} - {\tilde{η}}_{Bt} - {\tilde{ϵ}}_{i} - {\tilde{ϵ}}_{B} )}{E {u}_{B}^{′} ( 1 + {\tilde{R}}_{uB} )} , \\ i = 1 , … , n .$$

Further expanding for \tilde{R}_{uB}=μ_{Bt}+\tilde{η}_{Bt}+\tilde{ε}_{B}, we obtain as the solution

$${\dot{μ}}_{ei} = {μ}_{B} - \frac{E {u}_{B}^{′} ( 1 + {μ}_{B} + {\tilde{η}}_{Bt} + {\tilde{ϵ}}_{B} ) ( {\tilde{η}}_{ti} - {\tilde{η}}_{Bt} - {\tilde{ϵ}}_{i} - {\tilde{ϵ}}_{B} )}{E {u}_{B}^{′} ( 1 + {μ}_{B} + {\tilde{η}}_{Bt} + {\tilde{ϵ}}_{B} )} , \\ i = 1 , … , n .$$

One can easily see that the obtained ratio expression defines the covariance between a random variable ⊖,

$$⊖ = \frac{- {u}_{B}^{′} ( 1 + {μ}_{B} + {\tilde{η}}_{Bt} + {\tilde{ϵ}}_{B} )}{E {u}_{B}^{′} ( 1 + {μ}_{B} + {\tilde{η}}_{Bt} + {\tilde{ϵ}}_{B} )} ,$$

and the difference

\tilde{R}ᵤᵢ−\tilde{R}_{uB}.

Thus, one may write

μₑᵢ=μ_{B}+cov(⊖,\tilde{R}ᵢ−\tilde{R}_{B})

and note that the unconditional mean return for each asset equals the benchmark return plus the covariance between the variable ⊖, defined only by quantities of the benchmark, and the difference between the return of each asset i and the benchmark return; see R. C. Grinold, Mean-variance and scenario-based approaches to portfolio selection, Journal of Portfolio Management, 25(2), pages 10-22, 1999. This reflects an equilibrium pricing equation for expected utility optimization, and in particular here for asset returns represented by a factor model.

However, the equilibrium pricing equation did not help in the actual computation. Therefore we proceed to integrate the original equation and note that the random variables \tilde{ε}ₜ and \tilde{ε}_{B} are correlated (per the definition \tilde{ε}_{B}=\tilde{ε}^{T}x_{B}) with covariance

cov(\tilde{ε}ᵢ,\tilde{ε}_{B})=x_{Bi}σᵢ².

Thus, one may write for i=1, . . . , n,

$${μ}_{ei} = {μ}_{B} - \frac{E {u}_{B}^{′} ( 1 + {μ}_{B} + {\tilde{η}}_{Bt} + {σ}_{B} {z}_{1} ) ( {\tilde{η}}_{ti} - {\tilde{η}}_{Bt} - {σ}_{i} {z}_{2} - {σ}_{B} {z}_{1} )}{E {u}_{B}^{′} ( 1 + {μ}_{B} + {\tilde{η}}_{Bt} + {σ}_{B} z )}$$

where σ_{B}=\sqrt{x_{B}^{T}Σx_{B}} and where z₁ and z₂ are each N(0,1) with covariance

$$\frac{{x}_{Bi} {σ}_{i}}{{σ}_{B}} .$$

With

$${c}_{iB} = corr ( {\tilde{ϵ}}_{i} , {\tilde{ϵ}}_{B} ) = \frac{ϰ {B}_{i} {σ}_{i}}{{σ}_{B}}$$

we may compute the expectation as follows:

$$E {u}_{B}^{′} ( 1 + {μ}_{B} + {\tilde{η}}_{Bt} + {σ}_{B} {z}_{1} ) ( {\tilde{η}}_{ti} - {\tilde{η}}_{Bt} + {σ}_{i} {z}_{2} - {σ}_{B} {z}_{1} ) = {\sum }_{t} {p}_{t} {\int }_{- ∞}^{+ ∞} {\int }_{- ∞}^{+ ∞} {u}_{B}^{′} ( 1 + {μ}_{B} + {\tilde{η}}_{Bt} + {σ}_{B} {z}_{1} ) ( {\tilde{η}}_{ti} - {\tilde{η}}_{Bt} + {σ}_{i} {z}_{2} - {σ}_{B} {z}_{1} ) {p}_{i} ( {z}_{1} , {z}_{2} ) {dz}_{1} {dz}_{2}$$

where pᵢ(v, w) is the density function of the bivariate unit normal distribution,

$$p ( {z}_{1} , {z}_{2} ) = \frac{1}{2 π \sqrt{1 - {c}_{iB}^{2}}} exp ( - \frac{1}{2 ( 1 - {c}_{iB}^{2} )} [ {z}_{1}^{2} + {z}_{2}^{2} - 2 {c}_{iB} {z}_{1} {z}_{2} ] ) , \\ and$$

$$E {u}_{B}^{′} ( 1 + {μ}_{B} + {\tilde{η}}_{Bt} + {σ}_{B} z ) = {\sum }_{t} {p}_{t} \frac{1}{\sqrt{2 π}} {\int }_{- ∞}^{+ ∞} {u}_{B}^{′} ( 1 + {μ}_{B} + {\tilde{η}}_{Bt} + {σ}_{B} z ) {e}^{- \frac{{z}^{2}}{2}} dz$$

where we integrate numerically between, say, −5 and 5, which we found sufficiently accurate, using the known trapezoidal method. This had been proposed by G. Infanger, U.S. Pat. No. 8,548,890 B2, issued Oct. 1, 2013.

In the spirit of using a discrete approximation of the bivariate unit normal distribution, one could calculate p(z₁ᵥ_{₁}, z₂ᵥ_{₂}) corresponding to z₁ᵥ_{₁}, z₂ᵥ_{₂} for given correlation coefficient cis, using numerical integration. But the probability mass function would have to be computed separately for each asset i due to the dependency on c_{iB}. From a computational perspective, this would be similar to doing the integration directly as described above.

Therefore, we propose the following way of integrating via discrete approximation. Let L be the Cholesky factorization of the covariance matrix of the bivariate unit normal distribution with correlation c, i.e.,

$${LL}^{T} = ( \begin{matrix}1 & c \\ c & 1\end{matrix} ) .$$

One obtains, using algebra,

$$L = ( \begin{matrix}1 & 0 \\ c & \sqrt{1 - {c}^{2}} .\end{matrix} )$$

One may now obtain two dependent unit normal random variables

$$( \begin{matrix}1 & 0 \\ c & \sqrt{1 - {c}^{2}} .\end{matrix} ) ( \begin{matrix}{z}_{1} \\ {z}_{2}\end{matrix} )$$

that is, z₁ and cz₁+\sqrt{1−c²}z₂ as linear functions of z₁ and z₂ that are correlated with correlation coefficient c. Thus, one may calculate the expectations as

$$E {u}_{B}^{′} ( 1 + {μ}_{B} + {\tilde{η}}_{Bt} + {σ}_{B} {z}_{1} ) ( {\tilde{η}}_{ti} - {\tilde{η}}_{Bt} + {σ}_{i} {z}_{2} - {σ}_{B} {z}_{1} ) = {\sum }_{t} {\sum }_{{v}_{1}} {\sum }_{{v}_{2}} {u}_{B}^{′} ( 1 + {μ}_{B} + {\tilde{η}}_{Bt} + {σ}_{B} {z}_{{v}_{1}} ) ( {\tilde{η}}_{ti} - {\tilde{η}}_{Bt} + {σ}_{i} ( {c}_{iB} {z}_{{v}_{1}} + \sqrt{1 - {c}_{iB}^{2}} {z}_{{v}_{2}} ) - {σ}_{B} {z}_{{v}_{1}} ) {p}_{t} {p}_{{v}_{1}} {p}_{{v}_{2}}$$

$$and$$

$$E {u}_{B}^{′} ( 1 + {μ}_{B} + {\tilde{η}}_{Bt} + {σ}_{B} {z}_{v} ) = {\sum }_{t} {\sum }_{v} {u}_{B}^{′} ( 1 + {μ}_{B} + {\tilde{η}}_{Bt} + {σ}_{B} {z}_{v} ) {p}_{t} {p}_{v}$$

by using discrete approximations (zᵥ_{₁}pᵥ_{₁}), (zᵥ_{₂}pᵥ_{₂}), and (zᵥ,pᵥ) of the unit normal distributions, z₁, x₂, and z, respectively. The multiple sums may be readily implemented in a modeling language.

For the calibration, one needs to first quantify μ_{E}. Noting that \tilde{η}_{Bt}=(F^{T}V₀ₜ)^{T}x_{B} and using the benchmark utility function u_{B} (for, say, the power utility function, γ=γ_{B}), one obtains the unconditional means μₑ.

The calibrated expected utility maximization model

Having obtained μₑ from the above calibration, one may calculate

μ_{c}=μ−μₑ

and can write the expected utility maximization portfolio optimization model as follows:

$$max Eu ( 1 + {( \frac{1}{{γ}_{c}} {μ}_{c} + {μ}_{e} + {\tilde{η}}_{t} + \tilde{ϵ} )}^{T} x )$$

$$Ax = b , l \leq x \leq h ,$$

where γ_{c} scales the conditional expected returns. We call γ_{c} the active risk aversion, or the tilt parameter. The model will for u=u_{B} (for the power utility function, γ=γ_{B}) and γ_{c}→∝ result in the benchmark portfolio if the side constraints are relaxed. For smaller values of γ_{c} the model will tilt away from the benchmark portfolio to follow the active predictions μ_{c}. But also the overall, risk aversion γ, and more generally the utility function, may be chosen differently to obtain a suitable portfolio, different from the benchmark portfolio.

We implement the model as

$$max {Σ}_{t} {Σ}_{v} u ( 1 + {( \frac{1}{{γ}_{c}} {μ}_{c} + {μ}_{e} + {F}^{T} {V}_{0 t} )}^{T} x + σ ( x ) {z}_{v} ) {p}_{t} {p}_{v}$$

$$Ax = b , l \leq x \leq h , \\ where \\ σ ( x ) = \sqrt{{x}^{T} Σx} .$$

The result is a powerful model for active portfolio management, with the potential to effectively control downside risk by using an appropriate choice of utility function. It can be implemented in a modeling language, since the expected value is calculated based on multiple sums of discrete realizations representing with sufficient accuracy the factor model returns. No functions carrying out numerical integration need to be programmed.

Mean-Variance Optimization

In practical implementations of mean-variance portfolio optimization, the mean vector and the covariance matrix M need to be estimated. Historical, observations Rₜ, t=1, . . . , T, of \tilde{R} may be used to estimate the quantities. However, for a large number of assets, i.e., n>T, using sample averages directly to estimate the mean vector and the covariance matrix do not give the desired results, because the sample errors tend to be large and also the resulting covariance matrix is rank deficient (positive semidefinite rather than positive definite). In order to overcome this problem, factor models, as discussed above have been applied to model asset returns.

Using the factor model representation, the covariance matrix can be represented as

M=F^{T}M_{\tilde{V}}F+Σ,

where M_{\tilde{V}} is the k×k covariance matrix of the factors (or factor returns), and Σ=diag(σᵢ²) is the diagonal matrix of idiosyncratic variance, where σᵢ² is the variance of the i-th independent error term \tilde{ε}₂. The matrix M_{\tilde{V}} is, typically estimated using historical observations. Presuming all asset returns have positive variance, because Σ is diagonal, the resulting covariance matrix M is of full rank (rank(M)=n). The number of parameters to be estimated (nk for the factor loadings+k(k+1)/2 for the factor covariances+k for the means) is much smaller than without imposing the linear factor model ((n(n+1)/2 for the covariances+n for the means), especially when the number of factors k is kept reasonably small.

The mean-variance portfolio optimization problem based on a factor model representation of asset returns is

$$max {E ( {F}^{T} \tilde{V} )}^{T} x - \frac{γ}{2} {x}^{T} ( {F}^{T} {M}_{\tilde{V}} F + \sum ) x$$

$$Ax = b , l \leq x \leq h$$

An equivalent formulation arises when using the semi-parametric formulation of the factor model in accordance with the present invention directly:

$$max {μ}^{T} x - \frac{γ}{2} {\sum }_{t} {\sum }_{v} {( {( {F}^{T} {V}_{0 t} )}^{T} x + σ ( x ) {u}_{v} )}^{2} {p}_{t} {p}_{v}$$

$$Ax = b , l \leq x \leq h$$

where σ(x)=\sqrt{x^{T}Σx}. This is a scenario formulation of the mean-variance problem with Tm scenarios representing the covariance structure. The number of data points m representing N(0,1) determines the accuracy of the formulation. There does not appear to be a particular advantage of the scenario formulation over the typical factor model mean-variance formulation. If the unit normal distribution representation is sufficiently accurate, the scenario formulation will result in the same optimal portfolios as the typical factor model mean-variance formulation.

Calibrating the Mean-Variance Model to a Benchmark

The mean-variance portfolio optimization problem for calibrating unconditional expected returns is

$$max {μ}_{e}^{T} x - \frac{{γ}_{B}}{2} {x}^{T} M x$$

$${e}^{T} x = 1$$

where μₑ is the n-vector of unconditional mean returns to be determined, M=F^{T}M_{\tilde{V}}F+Σ is the n×n covariance matrix of asset returns, and γ_{B} is the risk aversion parameter of the benchmark.

The Lagrangian function of the mean-variance problem is

$$L ( x , λ ) = {μ}_{e}^{T} x - \frac{{γ}_{B}}{2} {x}^{T} M x + λ ( 1 - {e}^{T} x ) .$$

Setting all derivatives to zero one obtains:

$$\frac{\partial L ( x , λ )}{\partial x} = {μ}_{e} - {γ}_{B} M x - e λ = 0$$

$$and$$

$$\frac{\partial L ( x , λ )}{\partial λ} = 1 - {e}^{T} x = 0.$$

Multiplying on the left by x^{T}_{B}, one obtains

x_{B}^{T}μₑ−γ_{B}x_{B}^{T}(Mx_{B})−λ=0

and it follows that

λ=μ_{B}−γ_{B}σ₂^{B},

where μ_{B}=μₑ^{T}x_{B} and σ_{B}²=x_{B}^{T}x_{B}. Now we obtain for a given value of γ_{B}

μₑ=γ_{B}Mx_{B}+(μ_{B}−γ_{B}σ_{B}²)e

Note that the second term (μ_{B}−γ_{B}σ_{B}²)e is a constant and when added to the objective does not affect the solution of the mean-variance portfolio optimization problem. Therefore that term may be dropped. Thus,

μₑ=γ_{B}Mx_{B}.

We actually calculate the equilibrium returns μₑ by exploiting the factor model form of the covariance matrix as

μₑ=γ_{B}(F^{T}M_{\tilde{V}}F+Σ)x_{B}.

Equilibrium returns obtained for the mean-variance model, of course, differ from those obtained earlier for expected utility optimization, but both are labeled as μₑ. It should be clear from the context which is referred to.

The calibrated mean-variance model

Having obtained μₑ from the calibration, we calculate

μ_{c}=μ−μₑ

and may now write the mean-variance portfolio optimization model as:

$$max {( \frac{1}{{γ}_{c}} {μ}_{c} + {μ}_{e} )}^{T} x - \frac{γ}{2} {x}^{T} ( {F}^{T} {M}_{\tilde{V}} F + Σ ) x$$

$$Ax = b , l \leq x \leq h$$

or equivalently, using the semi-parametric formulation, as

$${max ( \frac{1}{{γ}_{c}} {μ}_{c} + {μ}_{e} )}^{T} x - \frac{γ}{2} {\sum }_{t}^{ } {\sum }_{v}^{ } {( {( {F}^{T} {V}_{0 t} )}^{T} x + σ ( x ) {z}_{v} )}^{2} {p}_{t} {p}_{v} \\ Ax = b , l \leq x \leq h$$

The model will for γ=γ_{B} and γ_{c}→∞ result in the benchmark portfolio if the side constraints are relaxed. For smaller values of γ_{c} the model will tilt away from the benchmark portfolio to follow the active predictions μ_{c}. The overall risk aversion γ may be chosen differently to obtain a suitable portfolio with a different risk than that of the benchmark portfolio.

Mean-Risk Optimization

Mean-risk optimization typically concerns portfolio optimization problems with risk measures other than portfolio variance, while mean-variance optimization is also a subset of mean-risk optimization with variance as the risk measure. Risk measures under consideration are either dispersion measures or downside risk measures. Besides variance (or standard deviation), important dispersion measures are mean absolute deviation and mean absolute moments. Important downside measures are semi-variance and lower partial moments, but most important in finance are the tail measures Value-at-Risk (VaR) and Conditional-Value-at-Risk (CVaR). We will present the formulation of the latter first and then discuss the other risk measures considered in mean-risk optimization.

Value-at-Risk and Conditional Value-at-Risk

Value-at-Risk is defined as

VaR_{α}(\tilde{R}^{T}x)=min{W: P(−\tilde{R}^{T}x>W)≤α)}.

It is the smallest number W such that the probability of a loss greater than W is no more than α. The quantity α is called the loss tolerance, whereas the quantity (1−α) is referred to as the confidence, level. VaR_{α} defines a quantile, for example the 5% quantile when α=0.05. An equivalent definition is VaR_{α}(\tilde{R}^{T}x)=−max{W: P(\tilde{R}^{T}x<W)≤α)}, where Value-at-Risk Is defined as the negative of the largest value W such that the probability of a return less than W is no more than α. The negative sign reflects that VaR is defined as a loss and not as a return.

For general distributions, Value-at-Risk is not a coherent measure of risk. It is not convex with respect to the portfolio variables x and is therefore difficult to optimize. However, Conditional-Value-at-Risk, defined as

CVaR_{α}(\tilde{R}^{T}x)=E{−\tilde{R}^{T}x|\tilde{R}^{T}x≤−VaR_{α}(\tilde{R}^{T}x)},

is convex with respect to the portfolio variables x. It is therefore well suited to mean-risk optimization, when tail risk is to be controlled. CVaR_{α} is the expected value of losses greater than or equal to the VaR_{α} quantile.

Other names for Conditional Value-at-Risk are Expected Shortfall and Tail Value of Risk. Since the losses in the tail are at least as much as VaR_{α}(\tilde{R}^{T}x), and CVaR_{α}(\tilde{R}^{T}x) is the average of these, it follows that

CVaR_{α}(\tilde{R}^{T}x)≥VaR_{α}(\tilde{R}^{T}x).

Thus, CVaR_{α} always dominates VaR_{α}. Therefore one may use CVaR_{α} in an optimization as a conservative approximation to VaR_{α}.

Let

Ψ(\tilde{R}^{T}x,W)=∫_{\tilde{R}}_{^{T}}_{x≤-W}p(\tilde{R})d\tilde{R}

be the probability of \tilde{R}^{T}x not exceeding a threshold−W. For a fixed portfolio x it is the cumulative distribution function of a loss associated with portfolio x. It is generally nondecreasing with respect to −W and is continuous with respect to −W as long as there are no jumps. For simplicity, only distributions with conthmous distribution functions are considered. However, while involving substantial technical detail, the analysis extends to non-continuous distribution functions as well.

Using the definition of Ψ, VaR_{α}(\tilde{R}^{T}x) may be written as

VaR_{α}(\tilde{R}^{T}x)=min{W: Ψ(\tilde{R}^{T}x,W)≤α)}

and CVaR_{α}(\tilde{R}^{T}x) may also be written as

$${CVaR}_{α} ( {\tilde{R}}^{T} x ) = \frac{1}{α} {\int }_{{\tilde{R}}^{T} x \leq - {VaR}_{α} ( {\tilde{R}}^{T} x )} - {\tilde{R}}^{T} xp ( \tilde{R} ) d \tilde{R}$$

Based on the above definitions; R. T. Rockafellar and S. Uryasev, Optimization of conditional value-at-risk, Portfolio Safeguard by AOrDa.com, 2(3), pages 21-41, 2000, defined the following function:

$${F}_{α} ( {\tilde{R}}^{T} x , W ) = W + \frac{1}{α} E \{ {( - {\tilde{R}}^{T} x - W )}^{+} \} ,$$

where Fₐ(\tilde{R}^{T}x, W), as a function of W, is convex and continuously differentiable in W for any value of x. Accordingly, CVaR_{α} and VaR_{α} for any value of x may be obtained as:

$$C V a {R}_{α} ( {\tilde{R}}^{T} x ) = {min}_{W} {F}_{α} ( {\tilde{R}}^{T} x , W ) and$$

$${VaR}_{α} ( {\tilde{R}}^{T} x ) ∈ arg {min }_{W} {F}_{α} ( {\tilde{R}}^{T} x , W ) .$$

Furthermore, CVaR_{α}(\tilde{R}^{T}x) is also convex. That is F_{α}(\tilde{R}(x), W) is convex for convex functions \tilde{R}(x) and, therefore, also for the linear function \tilde{R}^{T}x. Thus, CVaR is amenable to optimization:

$${min}_{x} C V a {R}_{α} ( {\tilde{R}}^{T} x ) = {min}_{W , x} {F}_{α} ( {\tilde{R}}^{T} x , W ) ,$$

where the function F_{α}(\tilde{R}^{T}x, W) is jointly minimized over (W, x). Given linear (or convex) portfolio constraints, one may minimize this convex function subject to linear (or convex) constraints. Thus, the obtained CVaR portfolio optimization problem is a convex optimization problem.

In particular, R. T. Rockafellar and S. Uryasev, Optimization of conditional value-at-risk. Portfolio Safeguard by AOrDa.com, 2(3), pages 21-41, MOO showed that when using a sample R_{ω}, ω∈S_{ω} of \tilde{R},

$${F}_{α} ( {R}_{ω}^{T} x , W ) = W + \frac{1}{α} \frac{1}{\vert {S}_{ω} \vert} {\sum }_{ω} {( - {\tilde{R}}_{ω}^{T} x - W )}^{+}$$

and, for this case, the portfolio optimization problem can be formulated as a linear program:

$$\begin{matrix}min W + \frac{1}{α} \frac{1}{\vert {S}_{ω} \vert} {\sum }_{ω} {v}_{ω} = & {CVaR}_{α} \\ {v}_{ω} + {R}_{ω}^{T} {x}_{i} + W \geq 0 , & {v}_{ω} \geq 0 , \\ {e}^{T} x = & 1 \\ {μ}^{T} x \geq & {\overline{r}}_{P}\end{matrix}$$

where \tilde{r}ₚ is a predefined desired value of portfolio expected return. At the optimal solution one obtains W*=VaR_{α}(R_{ω}^{T},x*), the Value-at-Risk of the optimal portfolio. Note that VaR_{α}(R_{ω}^{T}x*) is a sample average approximation of VaR_{α}(\tilde{R}^{T}x*) based on a return sample ω∈Sω_{.}

We proceed differently by using the factor model returns in the expression for CVaR_{α}(\tilde{R}^{T}x)=minus F_{α}(\tilde{R}^{T}x, W) to obtain:

$${CVaR}_{α} ( {\tilde{R}}^{T} x ) = {min}_{W} \{ W + \frac{1}{α} E \{ {( - {( {F}^{T} \tilde{V} + \tilde{ɛ} )}^{T} x - W )}^{+} \}$$

which is a convex function in x. Then,

$${CVaR}_{α} ( {R}^{T} x ) = {min}_{W} \{ W + \frac{1}{α} E \{ {( - {( {F}^{T} \tilde{V} )}^{T} x + σ ( x ) z - W )}^{+} \}$$

is a convex function in x. Using the semi-parametric factor model representation of asset returns in accordance with the present invention we calculate the expectation by multiple sums to obtain

$${CVaR}_{α} ( {R}_{t v}^{T} x ) = {min}_{W} \{ W + \frac{1}{α} {\sum }_{t} {\sum }_{v} \{ {( - {( {F}^{T} {V}_{t} )}^{T} x + σ ( x ) {z}_{v} - W )}^{+} \} {p}_{t} {p}_{v} ,$$

which is convex in x. One may implement this function via a nonlinear programming formulation as:

$$min W + \frac{1}{α} {\sum }_{t} {\sum }_{υ} {v}_{t v} {p}_{t} {p}_{v \\}$$

$$s / t {( {F}^{T} {V}_{t} )}^{T} x + σ ( x ) {z}_{v} + {v}_{t v} + W \geq 0 , {v}_{t v} \geq 0 , ∀ t , v$$

and minimize it subject to linear or convex portfolio constraints, thereby solving a convex program.

Changing the sign of the objective and maximizing an afflne transform of the objective with a positive coefficient leads to maximizing a concave functiOn subject to linear (or convex) constraints; a convex optimization problem. The following presents a new formulation of the mean-risk portfolio optimization probleth with CVaR as the risk measure for the factor model representation R^{T}x=(F^{T}Vₜ+\tilde{ε})^{T}x of asset returns as

$$max {μ}^{T} x - \frac{γ}{2} ( W + \frac{1}{α} {\sum }_{t} {\sum }_{v} {v}_{t v} {p}_{t} {p}_{v} )$$

$$\begin{matrix}{( {F}^{T} {V}_{t} )}^{T} x & + σ ( x ) {z}_{v} + {ν}_{t v} + W & \geq 0 , {v}_{t v} \geq 0 , ∀ t , v \\ Ax & & = b , l \leq x \leq h\end{matrix}$$

where σ(x)=\sqrt{x^{T}Σx}. At the optimal solution,

$${W}^{*} + \frac{1}{α} {\sum }_{t} {\sum }_{v} {v}_{t v}^{*} {p}_{t} {p}_{v} = {CVaR}_{α} ( {\overline{R}}^{T} {x}^{*} ) ,$$

the optimal Conditional Value-at-Risk value, and W*=VaR_{α}(\tilde{R}^{T}x*), the Value-at-Risk value of the returns of the optimal portfolio.

Note that by using the semi-parametric factor model representation of asset returns in accordance with the present invention a nonlinear program based on the nonlinear discrete formulation with Tm realizations is obtained. It is a convex problem as outlined above. We solve the problem by using gradient-based nonlinear programming techniques.

As in the case of mean-variance portfolio optimization, one would use

$$\frac{1}{{γ}_{c}} {μ}_{c} + {μ}_{e}$$

instead of μ, in order to facilitate a measured approach to active portfolio management. The equilibrium returns μₑ would be calibrated using the mean-variance model. The same also applies to the following models entailing different risk measures.

Other Risk Measures

Other Dispersion Measures

The following describes the mean-absolute-deviation (MAD) and the mean-absolute-moment (MAM) measures as part of mean-risk optimization.

The mean-absolute-deviation measure,

Risk(\tilde{R}^{T}x)=MAD(\tilde{R}^{T}x)=E|\tilde{R}^{T}x−E(\tilde{R}^{T}x)|,

introduced by H. Konno and H. Yamazaki, Mean-absolute deviation portfolio optimization model and its application to Tokyo stock market, Management Science, 37(5), pages 519-531. 1991, results in exactly the same optimal portfolio as mean-variance optimization if asset returns are multi-variate normally distributed. However, the portfolios are different to the extent that asset returns deviate froth the multi-variate normal distribution. When a sample of asset returns is used to represent the asset distribution, the mean-MAD model results in a linear program, and is, thus, easier to solve than the quadratic mean-variance problem. However, using factor models of asset returns, large-scale mean-variance models are routinely solved in a short time.

We now introduce a new formulation of the mean-MAD model for asset returns following the factor model R^{T}x=(F^{T}\tilde{V}+\tilde{ε})^{T}x using the semi-parametric approximation:

$$max {μ}^{T} x - \frac{γ}{2} {\sum }_{t} {\sum }_{v} ( {v}_{t v}^{+} + {ν}_{t v}^{-} ) {p}_{t} {p}_{v}$$

$$\begin{matrix}- {( {F}^{T} {V}_{0 t} )}^{T} x & - σ ( x ) {z}_{v} + {ν}_{t v}^{+} - {ν}_{t v}^{-} & = 0 , {v}_{t v}^{+} , {ν}_{t v}^{-} \geq 0 , ∀ t , v \\ Ax & & = b , l \leq x \leq h\end{matrix}$$

where σ(x)=\sqrt{x^{T}Σx}. It is a convex nonlinear problem, and can be solved using a modern nonlinear programming solver.

The mean-absolute-moment measure is defined as

Risk(\tilde{R}^{T}x)=MAM_{q}(\tilde{R}^{T}x)=E|\tilde{R}^{T}x−E(\tilde{R}^{T}x)|^{q},q>1,

Using the semi-parametric factor model representation of asset returns, the mean-MAM model can be stated directly as a convex nonlinear program (for q>1):

$$max {μ}^{T} x - \frac{γ}{2} {\sum }_{t} {\sum }_{v} {[ {( {( {F}^{T} {V}_{0 t} )}^{T} x + σ ( x ) {z}_{v} )}^{2} ]}^{q / 2} {p}_{t} {p}_{v}$$

$$Ax = b , l \leq x \leq h$$

where σ(x)=\sqrt{x^{T}Σx}, and where V₀ₜ is the observed demeaned part of the factor return. In order to account for the absolute value, for odd q, we first square the term in the objective and then raise it to the power of q/2. The problem may be solved using a gradient-based nonlinear programming solver. Note that for q=1, MAM₁(\tilde{R}^{T}=MAD(\tilde{R}^{T}x). Thus, the mean-MAM_{I} portfolio optimization problem equals the mean-MAD model described above.

An equivalent formulation that does not rely on the “squaring and then raising to the power of q/2” method of calculating the mean-absolute-moment is:

$$max {μ}^{T} x - \frac{γ}{2} {\sum }_{t} {\sum }_{v} {( {v}_{t v}^{+} + {ν}_{t v}^{-} )}^{q} {p}_{t} {p}_{v}$$

$$\begin{matrix}- {( {F}^{T} {V}_{0 t} )}^{T} x & - σ ( x ) {z}_{v} + {ν}_{t v}^{+} - {ν}_{t v}^{-} & = 0 , {v}_{t ν}^{+} , {ν}_{t ν}^{-} \geq 0 , ∀ t , v \\ Ax & & = b , l \leq x \leq h\end{matrix}$$

It is a convex problem, and can be solved using a gradient-based nonlinear programming solver.

Other Downside Measures

The following describes the semi-variance and the lower-partial-moment measures as part of mean-risk optimization.

The semi-variance is defined as,

Risk(\tilde{R}^{T}x)=σₛₑₘᵢ²(\tilde{R}^{T}z)=Emin(\tilde{R}^{T}x−E(\tilde{R}^{T}x),0)²,

where only return outcomes smaller than the expected return are considered in the standard deviation. Squaring makes the negative return values positive. Thus, the semi-variance, as defined above, is a risk measure in the sense that negative returns represent risk. Using the semi-parametric factor model representation of asset return, the mean-semi-variance model can be stated as:

$$max {μ}^{T} x - \frac{γ}{2} {\sum }_{t} {\sum }_{v} {v}_{t v}^{2} {p}_{t} {p}_{v}$$

$$\begin{matrix}{( {F}^{T} {V}_{0 t} )}^{T} x + σ ( x ) {z}_{v} + {ν}_{t v} & = 0 , {v}_{t ν} \geq 0 , ∀ t , v \\ Ax & = b , l \leq x \leq h\end{matrix}$$

where σ(x)=\sqrt{x^{T}Σx}, and where V₀ₜ is the demeaned part of the factor return. It is a convex nonlinear program, and is solved using a gradient-based nonlinear programming solver.

Lower partial moments are defined as

Risk(\tilde{R}^{T}x)=LPM_{q}w(\tilde{R}^{T}x)=E(−min(\tilde{R}^{T}x−W,0))^{q},q≥1

where W is a predefined value of return and risk is considered as the expected value of the negative of returns that are below the level W raised to the power of q. Using the semi-parametric factor model representation of asset returns, the mean-LPM model can be stated as:

$$max {μ}^{T} x - \frac{γ}{2} {\sum }_{t} {\sum }_{v} {v}_{t v}^{q} {p}_{t} {p}_{v}$$

$$\begin{matrix}{( {F}^{T} {V}_{ t} )}^{T} x + σ ( x ) {z}_{v} + {ν}_{t v} & \geq W , {v}_{t v} \geq 0 , ∀ t , v \\ Ax & = b , l \leq x \leq h\end{matrix}$$

where σ(x)=\sqrt{x^{T}Σx} and where W is a predefined constant. For q=1, risk is a linear measure, namely, the expected value of returns below the level W. In this case, the mean-LPM model becomes a linear program: For q>1 the mean-LPM model is a convex nonlinear program, and may be solved using a nonlinear programming solver.

Risk Constraints

Constraints on risk measures may be effectively used to control certain risk metrics in a mean-variance optimization or expected utility optimization. For example, one may want to explicitly control variance or tracking error in an expected utility problem, or one may want to control Value-at-Risk in a mean-variance problem. With the different risk measures discussed above, and considering mean-variance, expected utility, and mean-risk optimization problems, there are many combinations to analyze. For example, one combination is controlling Value-at-Risk in a mean-variance optimization problem by adding, a Conditional Value-at-Risk constraint. We use the semi-parametric representation of the factor model returns in the problem formulation. Let p be a given maximal Value-at-Risk level. One may formulate the CVaR constraint as part of the mean-variance optimization, as follows:

$$max {μ}^{T} x - \frac{γ}{2} {x}^{T} ( {F}^{T} {M}_{\overline{V}} F + \sum ) x$$

$$Ax = b , l \leq x \leq h$$

$$W + \frac{1}{α} {\sum }_{t} {\sum }_{v} {u}_{tv} {p}_{t} {p}_{v} \leq {ρ \\ ( {F}^{T} {V}_{t} )}^{T} x + σ ( x ) {z}_{v} + {u}_{tv} + W \geq 0 , {u}_{tv} \geq 0 , ∀ t , v$$

If the CVaR constraint is binding in the optimal solution, the variable W* represents the VaR value and the expression

$${W}^{*} + \frac{1}{α} {\sum }_{t} {\sum }_{v} {u}_{tv}^{*} {p}_{t} {p}_{v}$$

represents the CVaR value of the optimal solution x* of the problem. If the CVaR constraint is not binding, the obtained values of W* and

$${W}^{*} + \frac{1}{α} {\sum }_{t} {\sum }_{v} {u}_{tv}^{*} {p}_{t} {p}_{v}$$

may be arbitrary, and one only knows that both VaR and CVaR at the optimal solution x* are strictly less than ρ. A minor modification of the problem, where one assigns an extra variable to CVaR and penalizes it ever so slightly in the objective, will also provide VaR and CVaR values, when at the optimal solution the CVaR constraint is not binding.

Since the CVaR constraint is a convex constraint, the problem is a convex nonlinear programming problem.

Moment Constraints

As part of a portfolio optimization problem, higher moments of the returns distribution, in particular, skewness and/or kurtosis of portfolio returns, may need to be constrained. With portfolio returns defined as \tilde{R}^{T}x, for a given portfolio x, skewness is defined as

$$Skew = \frac{{E ( {\tilde{R}}^{T} x - E ( {\tilde{R}}^{T} x ) )}^{3}}{{( {E ( {\tilde{R}}^{T} x - E ( {\tilde{R}}^{T} x ) )}^{2} )}^{\frac{3}{2}}}$$

and kurtosis is defined as the fourth standardized moment,

$$Kurt = \frac{{E ( {\tilde{R}}^{T} x - E ( {\tilde{R}}^{T} x ) )}^{4}}{{( {E ( {\tilde{R}}^{T} x - E ( {\tilde{R}}^{T} x ) )}^{2} )}^{2}}$$

The term \tilde{R}^{T}x−E(\tilde{R}^{T}x) in the above definitions represents the demeaned portfolio returns. The normal distribution has a skewness of 0 and a kurtosis of 3. Therefore, excess kurtosis (K−3) is often used instead of kurtosis. Leptokurtic distributions (with a peakedness higher than that of the normal distribution) tend to have long tails also. An investor may seek a returns distribution that is not too negatively skewed and has limited kurtosis, in order to limit heavy left tails. Neither skewness nor kurtosis are convex functions of x.

We use the semi-parametric representation of factor model returns and calculate skewness and kurtosis. Using a variable uₜᵥ representing the demeaned portfolio returns,

vₜᵥ=(F^{T}V₀ₜ)^{T}x+σ(x)zᵥ,

where σ(x)=\sqrt{x^{T}Σx}, skewness is expressed as

$$Skew = \frac{{Eu}_{tv}^{3}}{{( {Eu}_{tv}^{2} )}^{\frac{3}{2}}}$$

and kurtosis as

$$Kurt = \frac{{Eu}_{tv}^{4}}{{( {Eu}_{tv}^{2} )}^{2}} .$$

Constraining skewness to be greater than or equal to a given lower bound Skews, we formulate

Evₜᵥ³−Skewₗ(Evₜᵥ²)^{3/2}≥0,

and using summation for calculating the expectations based on the discrete formulation of the factor model returns, one obtains

$${\sum }_{t} {\sum }_{v} {u}_{tv}^{3} {p}_{t} {p}_{v} - {{Skew}_{l} ( {\sum }_{t} {\sum }_{v} {u}_{tv}^{2} {p}_{t} {p}_{v} )}^{\frac{3}{2}} \geq 0.$$

The formulas simplify if one seeks to constrain skewness to be nonnegative (Skew≥0),

$${\sum }_{t} {\sum }_{v} {u}_{tv}^{3} {p}_{t} {p}_{v} \geq 0.$$

Constraining kurtosis to be less than or equal to a given upper bound Kurtₕ yields the following relation

Evₜᵥ⁴−Kurtₕ(Evₜᵥ²)²≤0

and using summation for calculating the expectations based on the discrete formulation of the factor model returns one obtains

$${\sum }_{t} {\sum }_{v} {u}_{tv}^{4} {p}_{t} {p}_{v} - {{Kurt}_{h} ( {\sum }_{t} {\sum }_{v} {u}_{tv}^{2} {p}_{t} {p}_{v} )}^{2} \leq 0.$$

Estimates based on samples of ratios of expectations and expectations taken to a power may be biased. Other formulations for sample skewness and sample kurtosis exist that include factors for bias correction.

As an example, a mean-variance model may be formulated where skewness is constrained to be nonnegative and kurtosis is constrained to be less than or equal to three:

$$max {μ}^{T} x - \frac{γ}{2} {\sum }_{t} {\sum }_{v} {u}_{tv}^{2} {p}_{t} {p}_{v} \\ Ax = b , l \leq x \leq h \\ - {( {F}^{T} {V}_{0 t} )}^{T} x - σ ( x ) {z}_{v} + {u}_{tv} = 0$$

$${\sum }_{t} {\sum }_{v} {u}_{tv}^{3} {p}_{t} {p}_{v} \geq 0$$

$${\sum }_{t} {\sum }_{v} {u}_{tv}^{4} {p}_{t} {p}_{v} - 3 {( {\sum }_{t} {\sum }_{v} {u}_{tv}^{2} {p}_{t} {p}_{v} )}^{2} \leq 0.$$

where σ(x)=\sqrt{x^{T}Σx}. It is a non-convex optimization problem, and multiple local optima may exist.

Derivative Securities

Derivative securities are securities whose price depends on the price of an underlying security. Derivative securities include, for example, options, fonvards, futures, swaps and others. Derivatives may be considered on an underlying, portfolio of assets, which includes options on an individual asset or options on an index. In order to obtain the return of a derivative security, its value is determined at the end of the investment period depending the value (return) of the underlying security. This may be shown using the example of options on a portfolio of assets (index). Let K be the strike price and p be the price of the option, expressed as a fraction of the price of the underlying security (index). The return of a call option is

$${r}^{call} = \frac{max \{ 0 , {p}_{s 0} ( 1 + {\tilde{R}}_{U} ) - {p}_{s 0} K \}}{{p}_{s 0} p} - 1 ,$$

where pₐ₀ is the price of the underlying security at the beginning of the investment period and \tilde{R}_{U} is its return. Dividing by pₛ₀ one obtains:

$${r}^{call} = \frac{max \{ 0 , ( 1 + {\tilde{R}}_{U} ) - K \}}{p} - 1 ,$$

the return of a call option depending: on the return of the underlying security. Similarly, the return of a put option is

$${r}^{put} = \frac{max \{ 0 , k - ( 1 + {\tilde{R}}_{U} ) \}}{p} - 1$$

depending on the return of the underlying security. Let [symbol] be a specific option, put or call, with relative strike price K and relative price p. Then, one may define the return of an option [symbol] on the underlying portfolio x_{U} as

rₗ=fₗ(\tilde{R}^{T}x_{U})

where fₗ(·) is the return generating function of option [symbol] and \tilde{R}_{U}=\tilde{R}^{T}x_{U}. In general, one may define τₗ=fₗ(\tilde{R}^{T}x_{U}) as the return generation function of derivative security [symbol] , defining its return based on the return \tilde{R}^{T}x_{U} of the underlying portfolio of assets.

Let f be the n_{d}-vector of return generating functions of various derivative securities and let y be the n_{d}-vector of holdings of these derivative securities. In portfolio optimization, one needs to maximize the expectation of a function G of the portfolio return. Accordingly, with derivatives in the portfolio one obtains:

max EG(\tilde{R}^{T}x+f^{T}(\tilde{R}^{T}x_{U})y)

subject to portfolio constraints on n+n_{d} assets. Substituting the factor model representation. we obtain:

max EG((F^{T}Vₜ+\tilde{ε})^{T}x+f^{T}((F^{T}Vₜ+\tilde{ε})^{T}x_{U})y)

and using the semi-parametric reformulation described above,

max EG(R_{Ft}^{T}x+σ(x)z₁+f^{T}(R_{Ft}^{T}x_{U}+σ_{U}z₂)y)

where z₁ and z₂ are unit normal random variables correlated with correlation coefficient

$${c}_{xU} = \frac{{x}^{T} \sum {x}_{u}}{σ ( x ) {σ}_{U}} = \frac{\sum {x}_{i} {x}_{Ui} {σ}_{i}^{2}}{\sqrt{{\sum }_{i}^{ } {σ}_{i}^{2} {x}_{i}^{2}} {σ}_{U}}$$

and where σ_{U}=\sqrt{x_{U}^{T}Σx_{U}}=\sqrt{Σᵢσᵢ²x_{Ui}²}. For any given value of x and y one may integrate this function using two-dimensional numerical integration as

$$max {\sum }_{t} {\int }_{- ∞}^{+ ∞} {\int }_{- ∞}^{+ ∞} G ( {R}_{Fi}^{T} x + σ ( x ) {z}_{1} + {f}^{T} ( {R}_{Fi}^{T} {x}_{U} + {σ}_{U} {z}_{2} ) y ) {p}_{t} p ( {z}_{1} , {z}_{2} ) {dz}_{1} {dz}_{2} where$$

$$p ( {z}_{1} , {z}_{2} ) = \frac{1}{2 π \sqrt{1 - {c}_{xU}^{2}}} exp ( - \frac{1}{2 ( 1 - {c}_{xU}^{2} )} [ {z}_{1}^{2} + {z}_{2}^{2} - 2 {c}_{iB} {z}_{1} {z}_{2} ] ) .$$

This was proposed in G. Infanger, U.S. Pat. No. 8,548,890 B2, issued Oct. 1, 2013, where the numerical integration was carried out using the trapezoidal method integrating between −5 and 5. Gradients were provided and the resulting problem was solved using a gradient-based nonlinear optimization algorithm. The approach worked well and led to short computation times.

We now extend the approach to using the discrete approximation of the unit normal variables. Using the Cholesky factorization described above, one obtains two dependent unit random variables with correlation coefficient c_{xU} as z₁ and c_{xU}z₁+\sqrt{1−c_{xU}²}z₂, where now z₁ and z₂ are two independent unit normal variables. Using the discrete approximations (zᵥ_{₁},pᵥ_{₁}) and (zᵥ_{₂},pᵥ_{₂}) for z₁ and z₂, one obtains:

$$max {\sum }_{t} {\sum }_{{v}_{1}} {\sum }_{{v}_{2}} G ( {R}_{Fi}^{T} x + σ ( x ) {z}_{{v}_{1}} + {f}^{T} ( {R}_{Fi}^{T} {x}_{U} + {σ}_{U} ( {c}_{xU} {z}_{{v}_{1}} + \sqrt{1 - {c}_{xU}^{2}} {z}_{{v}_{2}} ) ) y ) {p}_{t} {p}_{{v}_{1}} {p}_{{v}_{2}}$$

subject to portfolio constraints. The portfolio optimization problem including derivatives on an underlying portfolio of assets (index) can now be carried out using multiple sums. Thus, it can be implemented in a modeling system. Note that a single asset is a portfolio with one position and, thus, derivatives on a single asset are covered by this approach in the same way. However, derivatives on each of multiple underlying assets cannot be handled by the approach, since this would lead to many multiple sums (two plus one for each underlying asset) and would be computationally prohibitive.

Calculating Performance Statistics

In any portfolio optimization context, it is often useful to provide forward-looking (or a ante) statistics, including (predicted values of) portfolio mean return, standard deviation, and Sharpe ratio. These can be calculated based on the covariance structure of asset returns. Forward-looking statistics involving downside measures, including downside standard deviation, or Value-at-Risk are more difficult to calculate, unless they are based on assuming normally distributed returns. Using the factor model returns for a given portfolio x, forward-looking statistics involving downside risk can be calculated, taking advantage of the semi-parametric formulation of the factor model returns. The following shows this for the Sortino (SoR) ratio and for Value-at-Risk (VaR).

Forward-Looking Downside Target Standard Deviation and Sortino Ratio

For a Given Portfolio x_{P}. We May Write the Factor Model Returns as

R_{Ptv}=R_{Ft}^{T}x_{P}+σ(x_{P})zᵥ,

where R_{Ptv} are Tm forward-looking return realizations with corresponding probability pₜpᵥ, representing the forward-looking returns distribution of portfolio x_{P}.

The downside target standard deviation is defined as

\sqrt{E[min(\tilde{R}^{T}x_{P}−r_{f},0)]²}

and is the square root of the lower partial moment of order 2 of \tilde{R}^{T}x_{P}, with the risk-free rate r_{f} as the target rate.

The Sortino Ratio is defined as

$$SoR = \sqrt{{n}_{Y}} \frac{E ( {\tilde{R}}^{T} {x}_{P} - {r}_{f} )}{\sqrt{{E ( min ( {\tilde{R}}^{T} {x}_{P} - {r}_{f} , 0 ) ]}^{2}}}$$

This is the scaled ratio of the excess returns (over the risk-free rate r_{f}) divided by the downside target standard deviation. It is typically expressed in annual terms. If returns are observed n_{Y} times per year, the Sortino ratio obtained from the observations is annualized by multiplying with \sqrt{n_{Y}}. For example, when using monthly observations, one multiplies by \sqrt{12}.

The forward-looking Sortino Ratio based on the semi-parametric factor model returns is

$$SoR = \sqrt{{n}_{Y}} \frac{{E}_{t} {R}_{FPt} {p}_{t} - {r}_{f}}{\sqrt{{\sum }_{t} {\sum }_{v} {[ min ( {R}_{{Pt}_{v}} - {r}_{f} , 0 ) ]}^{2}} {p}_{t} {p}_{v}}$$

where r_{f} is the forward-looking risk-free rate (the current one). The denominator is the downside target standard deviation based on the factor model returns. It is also scaled by \sqrt{n_{Y}}. Note that for T=60 observations and m=51, the total number of return realizations is 3,060, enough points to expect an accurate representation of downside frisk.

Forward-Looking VaR and CVaR for Portfolio Analysis

Using the return realizations obtained from the factor model representation with corresponding probabilities,

R_{Ptv}=R_{FPt}÷σ_{P}zᵥpₜᵥ=pₜpᵥ

we may compute the Value-at-Risk (VaR_{α}) by sorting the outcomes of R_{Ptv} from the smallest to the largest value (maintaining the corresponding pₜᵥ). Call the sorted outcomes rⱼ, j=1, . . . , Tm such that after sorting, (r₁, p₁) is the smallest outcome with corresponding probability. (r₂, p₂) is the second smallest outcome with corresponding probability, etc. One may then construct

| | | | | |
|---|---|---|---|---|
| P₁ | P₂ | P₃ | P₄ | . . . |
| p₁ | p₂ | p₃ | p₄ | . . . |
| r₁ | r₂ | r₃ | r₄ | . . . |

where Pⱼ are the cumulative probabilities, i.e.,

$${P}_{j} = {\sum }_{k = 1}^{j} {p}_{k}$$

Now find the smallest index j* for which Pⱼ equals or exceeds α.

If Pⱼ*=a, then VaR_{α}=rⱼ*

If Pⱼ*>α. then VaR_{α}=r_{j*÷1}.

Then, the conditional Value-at-Risk may be calculated as

$${CVaR}_{α} = \frac{1}{α} {\sum }_{j = 1}^{{j}_{α}} {r}_{j} {p}_{j} where {j}_{α} = j \vert r ( j ) = {VaR}_{α} .$$

With this calculation, one obtains a forward-looking Value-at-Risk and a forward-looking conditional Value-at-Risk that are not based on assuming normally distributed returns and, thus, reflect downside risk more accurately.

While the foregoing description has been with reference to particular examples of the present invention, it will be appreciated by those skilled in the art that changes to these examples may be made without departing from the principles and spirit of the invention. Accordingly, the scope of the present invention can only be ascertained with reference to the appended claims.

What is claimed is:

1. A method using a computer having a processor configured to execute instructions which when executed cause the computer to perform steps to manage a portfolio of financial assets to provide large-scale portfolio optimization, including mean-variance optimization, expected utility maximization, and general mean-risk portfolio optimization, where asset returns are represented by a factor model, comprising the steps of:
selecting from multiple financial assets a mix of a plurality of available financial assets comprising the portfolio of financial assets which is to be managed;
selecting a factor model which represents a distribution of asset returns for the plurality of financial assets for a selected subsequent period of time for which the portfolio is to be managed, wherein asset returns in each period of time t≥1 follow a factor model,
\tilde{R}ₜ=\tilde{F}ₜ^{T}\tilde{V}ₜ+\tilde{ε}ₜ,
where \tilde{F}ₜ is a k×n random matrix of factor loadings, \tilde{V}ₜ is a random k-vector of the values of the factors including a mean vector, if the random value of the first factor is defined as always having the value 1, and \tilde{ε}ₜ is a random n-vector of idiosyncratic returns where the idiosyncratic returns \tilde{ε}ₜ are multi-variate normally distributed, \tilde{ε}ₜ=N(0, Σₜ), where the covariance Σₜ=diag(σᵢₜ²), and \tilde{ε}ₜ is assumed independently distributed, between its components, respectively, and independently distributed with respect to \tilde{V}ₜ;
defining a first statistical model applicable to macro-economic factor models by letting \tilde{F}ₜ=F be constant, \tilde{V}ₜ for t≥1 and \tilde{ε}ₜ for t≥0.1 each be independently and identically distributed random variables such that \tilde{R}ₜ=F^{T}\tilde{V}ₜ+\tilde{ε}ₜ for t≥1 is an independently and identically distributed random variable, so that observing at each period t=1, . . . T an outcome Rₜ, Vₜ, and εₜ of \tilde{R}ₜ, \tilde{V}ₜ, and \tilde{ε}ₜ, respectively, at period T+1, the current period at which a portfolio decision is to be, made, the random vector of asset returns is
\tilde{R}_{T+1}|\tilde{R}₁, . . . ,\tilde{R}_{T}=F^{T}\tilde{V}_{T+1}|\tilde{V}₁, . . . ,\tilde{V}_{T}+\tilde{ε}_{T+1}|\tilde{ε}₁, . . . ,\tilde{ε}_{T}.
and based on independence,
\tilde{R}_{T+1}=F^{T}\tilde{V}_{T+1}+\tilde{ε}_{T+1}
which results in
\tilde{R}=F^{T\tilde{V}+\tilde{ε}}
by setting \tilde{R}≡\tilde{R}_{T+1}, \tilde{V}≡\tilde{V}_{T+1} and \tilde{ε}≡\tilde{ε}_{T+1}, thereby suppressing the time index for period T+1 such that \tilde{ε}=N(0, Σ), where Σ=diag(σᵢ²);
defining a second statistical model applicable to fundamental factor models by letting \tilde{F}ₜ for t≥1 be a sequence of independently and identically distributed random variables and, conditional on \tilde{F}ₜ, letting \tilde{V}ₜ and \tilde{ε}ₜ for t≥1 each be independently and identically distributed random variables such that \tilde{R}ₜ|\tilde{F}ₜ=\tilde{F}ₜ^{T}\tilde{V}ₜ|\tilde{F}ₜ+\tilde{ε}ₜ|\tilde{F}ₜ is an independently and identically distributed random variable so that observing at each period t=1, . . . T an outcome Rₜ, Vₜ, Fₜ, and εₜ of \tilde{R}ₜ, \tilde{V}ₜ, \tilde{F}ₜ, and \tilde{ε}ₜ, respectively, and an outcome F_{T+1} of \tilde{F}_{T+1}, at the current period T+1 at which a portfolio decision is to be made, the random vector of asset returns is
\tilde{R}_{T+1}|\tilde{R}₁,\tilde{F}₁, . . . ,\tilde{R}_{T},\tilde{F}_{T},\tilde{F}_{T+1}=\tilde{F}_{T÷1}^{T}\tilde{V}_{T+1}|\tilde{V}₁,\tilde{F}₁, . . . ,\tilde{V}_{T},\tilde{F}_{T},\tilde{F}_{T+1}+\tilde{ε}_{T+1}|\tilde{ε}₁,\tilde{F}₁, . . . ,\tilde{ε}_{T},\tilde{F}_{T},\tilde{F}_{T+1}
and based on independence,
\tilde{R}_{T÷1}|\tilde{F}_{T+1}=\tilde{F}_{T+1}^{T}\tilde{V}_{T+1}|\tilde{F}_{T+1}+\tilde{ε}_{T+1}|\tilde{F}_{T+1}
and since at period T+1, an outcome F_{T+1} of \tilde{F}_{T+1} is obtained
\tilde{R}=F^{T}\tilde{V}+\tilde{ε}
by setting \tilde{R}≡\tilde{R}_{T+1}|\tilde{F}_{T+1}=F_{T+1}, \tilde{V}≡\tilde{V}_{T+1}|\tilde{F}_{T+1}=F_{T+1}, \tilde{ε}≡\tilde{ε}_{T+1}|\tilde{F}_{T+1}=F_{T+1}, and F=F_{T+1}, thereby suppressing the time index T+1 and the dependency on the observed value F_{T÷1}, of \tilde{F}_{T+1} such that \tilde{ε}=N(0, Σ), where E=diag(σᵢ²);
maximizing expected value of a function of the portfolio return defined as max EG(\tilde{R}^{T}x) such that for mean-variance portfolio optimization the result is max
$$E {\tilde{R}}^{T} x - \frac{γ}{2} Risk ( {\tilde{R}}^{T} x ) ;$$
for utility maximization the result is max Eu(1+\tilde{R}^{T}x), and for mean-risk optimization the result is max
$$E {\tilde{R}}^{T} x - \frac{γ}{2} var ( {\tilde{R}}^{T} x ) ,$$
approximating a unit normal random variable z by a discrete random variable
ζ=(zᵥ,pᵥ)
with realizations zᵥ occurring with probability pᵥ, for v=1, . . . , m such that the continuous unit normal distribution is represented by a histogram with properties that its mean is zero, E(ζ)=0, its variance is approximately one, E(ζ²)≈1, and its higher moments match closely those of the unit normal distribution so that for a sufficiently large number of discrete outcomes, the discrete representation closely approximates the unit normal distribution
$${lim}_{m \to ∞} {max}_{z} \vert ( z ) - 𝒬 ( z ) \vert = 0 ,$$
and the cumulative distribution function of the discrete approximation [symbol] (z) substantially corresponds to the cumulative distribution function Q(z) of the unit normal distribution;
utilizing a discrete approximation ζ of the unit normal random variable z to determine the asset returns of the portfolio generated by the factor model for any realization zᵥ of ζ as
\tilde{R}ᵥ=(F^{T}\tilde{V})^{T}x+σ(x)zᵥ,
defining the expected value as a function of the portfolio return as
$$EG ( {\tilde{R}}_{v} ( x ) ) = {\int }_{- ∞}^{+ ∞} {\sum }_{v} G ( {( {F}^{T} \tilde{V} )}^{T} x + σ ( x ) {z}_{v} ) {p}_{v} dP ( \tilde{V} ) ;$$
obtaining a discrete representation of the factor model returns as
Rᵢᵥ(x)=(F^{T}Vₜ)^{T}x+σ(x)zᵥ,
with associated probabilities Pₜᵥ=pₜpᵥ;
defining another discrete random vector [symbol] (x)=(Rₜᵥ(x),pₜᵥ) with outcomes Rₜᵥ(x) and associated probability pₜᵥ and utilizing a sample-average approximation defined by empirically observed outcomes Vₜ with corresponding probability
$${p}_{t} = \frac{1}{T}$$
to determine a conditional expectation, given ζ=zᵥ, as
$$EG ( ( x ) ) \vert ζ = {\sum }_{i} G ( {( {F}^{T} {V}_{t} )}^{T} x + σ ( x ) {z}_{v} ) {p}_{t} ,$$
where
$${p}_{t} = \frac{1}{T}$$
such that for a sufficiently large number T of observations Vₜ, EG( [symbol] (x))|ζ approximates EG(\tilde{R}ᵥ(x))|ζ, as EG( [symbol] (x))|ζ→EG(\tilde{R}ᵥ(x))|ζ as T→∞; and
determining an expectation EG( [symbol] (x)) as a multiple sum:
$$EG ( \tilde{R} ( x ) ) = {\sum }_{t} {\sum }_{v} G ( {( {F}^{T} {V}_{t} )}^{T} x + σ ( x ) {z}_{v} ) {p}_{t} {p}_{v} ,$$
and EG( [symbol] (x)) approximates EG(\tilde{R}(x)), as EC( [symbol] (x))→EG(\tilde{R}(x)) as T→∞ and as ζ approximates z;
whereby for a general factor model representation of asset returns, portfolio returns are expressed as a function of x as a random variable with a discrete distribution representing a semi-parametric approximation, since the idiosyncratic component of the asset returns is represented parametrically and the factor explained component is represented non-parametrically and any expectation of functions of portfolio returns that may occur in a portfolio optimization model can therefore be computed by multiple sums (over t and v);
thereby making portfolio optimization tractable and to facilitate solution.

2. The method of claim 1 wherein a discrete approximation of the unit normal distribution, obtained using optimization, is based on 51 equally spaced points between −5 and +5 and substantially corresponds to the unit normal distribution wherein its, first 8 moments are mean=0:000000, variance=1.000000, skewness=0.000000, kurtosis=3.000000, m₅=0.000000, m₆=15.000000, m₇=0.000000, and m₈=105.000000 and a tail area of
$$\frac{1}{\sqrt{2 π}} {\int }_{- x}^{- 5} {xe}^{- \frac{{x}^{- 2}}{2}} dz = 2.8665 e - 07$$
of probability mass is all that is not captured on either side of the unit normal distribution and, utilizing 6 standard deviations, the one sided error is 9.8659e−10.

3. The method of claim 1, further comprising the steps of:
partitioning the factor explained returns F^{T}\tilde{V} into a demeaned part F^{T}\tilde{V}₀ and its mean vector μ=F^{T}E\tilde{V}, where \tilde{V}=μ+\tilde{V}₀ such that the factor-explained returns are \tilde{R}_{F}=μ+F^{T}\tilde{V}₀ and the factor model returns are expressed as \tilde{R}=μ+F^{T}\tilde{V}₀+\tilde{ε} and observed outcomes of \tilde{V}₀ are denoted as V₀ₜ and observed outcome of \tilde{R}_{F} are denoted as R_{Ft}; and
determining expected utility maximization with a factor model representation of asset returns, comprising:
defining the expected utility maximization
max E u(1+(F^{T}\tilde{V}+\tilde{ε})^{T}x)
Ax=b,l≤x≤h
utilizing the semi-parametric discrete factor model representation of asset returns as:
max ΣₜΣᵥu(1+R_{Ft}^{T}x+σ(x)zᵥ)pₜpᵥ
Ax=b,l≤x≤h,
where σ(x)=\sqrt{x²Σx} to provide a discrete formulation with Tm realizations representing accurately the factor model of returns, where for each outcome t there are in outcomes representing the unit normal distribution multiplied with the nonlinear term σ(x);
obtaining gradients with respect to the decision variables xᵢ as
$$\frac{\partial }{\partial {x}_{i}} {\sum }_{t} {\sum }_{v} u ( 1 + {R}_{Ft}^{T} x + σ ( x ) {z}_{v} ) {p}_{t} {p}_{v} = {\sum }_{t} {\sum }_{v} {u}^{′} ( 1 + {R}_{Ft}^{T} x + σ ( x ) {z}_{v} ) ( {\tilde{R}}_{Fi} + \frac{1}{σ ( x )} {σ}_{i}^{2} {x}_{i} {z}_{v} ) {p}_{i} {p}_{v}$$
for each i=1 . . . , n, where σ(x)=\sqrt{x^{T}Σx}; and
utilizing a gradient-based nonlinear optimization program running on a processor to determine the expected utility maximization.

4. The method of claim 3, further comprising the steps of:
obtaining equilibrium returns (de such that the expected utility maximization
max E u(1+(μₑ+F^{T}V₀ₜ+ε)^{T}x)
e^{T}x=1
for the utility function of a benchmark u=u_{B} results in a benchmark portfolio x_{B}:
$${μ}_{ei} = {μ}_{B} - \frac{E {u}_{B}^{′} ( 1 + {μ}_{B} + {η}_{Bt} + {ϵ}_{B} ) ( {η}_{ti} - {η}_{Bt} + {ϵ}_{i} - {ϵ}_{B} )}{E {u}_{B}^{′} ( 1 + {μ}_{B} + {η}_{Bt} + {ϵ}_{B} )} i = 1 , … , n ,$$
where Θ_{Bt}=F^{T}V₀ₜ^{T}x₈ is the demeaned factor-explained return; and
determining the expectations for the equilibrium returns utilizing a semi-parametric discrete representation as
$$E {μ}_{B}^{′} ( 1 + {μ}_{B} + {η}_{Bt} + {σ}_{B} {z}_{1} ) ( {η}_{ti} - {η}_{Bt} + {σ}_{i} {z}_{2} - {σ}_{B} {z}_{1} ) = {\sum }_{t} {\sum }_{{v}_{1}} {\sum }_{{v}_{2}} {u}_{B}^{′} ( 1 + {μ}_{B} + {η}_{Bt} + {σ}_{B} {z}_{{v}_{1}} ) ( {η}_{ti} - {η}_{Bt} + {σ}_{i} ( {c}_{iB} {z}_{{v}_{1}} + \sqrt{1 - {c}_{iB}^{2}} {z}_{{v}_{2}} ) - {σ}_{B} {z}_{{v}_{1}} ) {p}_{t} {p}_{{v}_{1}} {p}_{{v}_{2}}$$
$$and$$
$$E {μ}_{B}^{′} ( 1 + {μ}_{B} + {η}_{Bt} + {σ}_{B} {z}_{v} ) = {\sum }_{t} {\sum }_{v} {u}_{B}^{′} ( 1 + {μ}_{B} + {η}_{Bt} + {σ}_{B} {z}_{v} ) {\underline{p}}_{t} {p}_{v}$$
by Ling discrete approximations ζ₁=(zᵥ_{₁},pᵥ_{₁}), ζ₂=(zᵥ_{₂},pᵥ_{₂}), and ζ₃=(zᵥ,pᵥ) of the independent unit normal random variables z₁, z₀, and z, respectively.

5. The method of claim 4, further comprising the step of:
utilizing μₑ to determine
μₑ=μ−μₑ,
where μ=F^{T}E\tilde{V} is the mean value of the factor explained return to determine the expected utility maximization portfolio model based on semi-parametric discrete factor model representation of asset returns as
$$max {\sum }_{t} {\sum }_{v} u ( 1 + {( \frac{1}{{γ}_{c}} {μ}_{c} + {μ}_{e} + {F}^{T} {V}_{0 t} )}^{T} x + σ ( x ) {z}_{v} ) {p}_{t} {p}_{v}$$
$$Ax = b , l \leq x \leq h ,$$
where σ(x)=\sqrt{x^{T}Σx} and γₑ scales the conditional expected returns.

6. The method of claim 1, further comprising determining mean-variance portfolio optimization with a factor model representation of asset returns, comprising the steps of:
utilizing a factor-model-based covariance representation
$$max {E ( {F}^{T} \tilde{V} )}^{T} x - \frac{γ}{2} {x}^{T} ( {F}^{T} {M}_{\tilde{V}} F + \sum ) x$$
$$Ax = b , l \leq x \leq h$$
where M_{\tilde{V}} is a=k×k covariance matrix of the factors and Σ=diag(σᵢ²) is the diagonal matrix of idiosyncratic variance; and
determining the variance σᵢ² of the i-th independent error term \tilde{ε}ᵢ using the semi-parametric discrete factor model representation of asset, returns as
max μ^{T}x−γ/2ΣₜΣᵥ((F^{T}V₀ₜ)^{T}x+σ(x)uᵥ)²pₜpᵥ
Ax=b,l≤x≤h,
where σ(x)=\sqrt{x^{T}Σx} to represent a scenario formulation, Of mean-variance having Tm scenarios representing a covariance structure using a gradient-based nonlinear program running on a processor.

7. The method of claim 6, further comprising the steps of:
obtaining equilibrium returns μₑ utilizing the factor model as
μₑ=γ_{B}(F^{T}M_{\tilde{V}}F+Σ)x_{B}
to determine
μ_{c}=μ−μₑ; and
determining the mean-variance portfolio optimization as
$${max ( \frac{1}{{γ}_{c}} {μ}_{c} + {μ}_{e} )}^{T} x - \frac{γ}{2} {\sum }_{t} {\sum }_{v} {( {( {F}^{T} {V}_{0 t} )}^{T} x + σ ( x ) {z}_{v} )}^{2} {p}_{t} {p}_{v}$$
$$Ax = b , l \leq x \leq h$$

8. The method of claim 1, further comprising determining mean-risk portfolio optimization with a factor model representation of asset returns, comprising the steps of:
defining the probability of the asset returns of a portfolio x as
Ψ(\tilde{R}^{T}x,W)=∫_{\tilde{R}}_{^{T}}_{x≤-W}p(\tilde{R})d\tilde{R},
where \tilde{R}^{T}x does not exceed a threshold W;
defining Value-at-Risk VaR_{α}(\tilde{R}^{T}x) for continuous distribution functions as
VaR_{α}(\tilde{R}^{T}x)=min{W: Ψ(\tilde{R}^{T}x,W)≤α)};
defining Conditional-Value-at-Risk CVaR_{α}(\tilde{R}^{T}x) for continuous distribution functions as
$${CVaR}_{α} ( {\tilde{R}}^{T} x ) = \frac{1}{α} {\int }_{{\tilde{R}}^{T} x \leq - {VaR}_{α} ( {\tilde{R}}^{T} x )}^{ } - {\tilde{R}}^{T} xp ( \tilde{R} ) d \tilde{R} ;$$
utilizing the definitions for Value-at-Risk and Conditional-Value-at-Risk and a function
$${F}_{α} ( {\tilde{R}}^{T} x , W ) = W + \frac{1}{α} {E ( - {\tilde{R}}^{T} x - W )}^{+}$$
to define the mean-risk portfolio optimization with Conditional-Value-at-Risk as the risk measure as
$${max ( E \tilde{R} )}^{T} x - \frac{γ}{2} {CVaR}_{α} ( {\tilde{R}}^{T} x )$$
$$Ax = b , l \leq x \leq h ;$$
determining
$${CVaR}_{α} ( {\tilde{R}}^{T} x ) = {min}_{W , x} {F}_{α} ( {\tilde{R}}^{T} x , W )$$
using the semi-parametric and discrete representation of the factor model returns as
$$max {μ}^{T} x - \frac{γ}{2} ( W + \frac{1}{α} {\sum }_{t} {\sum }_{v} {u}_{tv} {p}_{t} {p}_{v} )$$
$${( {F}^{T} {V}_{t} )}^{T} x + σ ( x ) {z}_{v} + {u}_{tv} + W \geq 0 , {u}_{tv} \geq 0 , ∀ t , v$$
$$Ax = b , l \leq x \leq h ,$$
where σ(x)=\sqrt{x^{T}Σx}; and
utilizing a gradient-based nonlinear optimization program running on a processor to determine
$${W}^{*} + \frac{1}{α} {\sum }_{t} {\sum }_{v} {u}_{tv}^{*} {p}_{t} {p}_{v} = {CVaR}_{α} ( {R}^{T} {x}^{*} )$$
as the optimal Conditional-Value-at-Risk value and W*=VaR_{α}(\tilde{R}^{T}x*) as the Value-at-Risk value of the returns of the optimal portfolio.

9. The method of claim 1, further comprising determining mean-risk portfolio optimization with a factor model representation of asset returns, comprising the steps of:
defining mean-risk portfolio optimization with mean-absolute-deviation (MAM) as a risk measure as
$${max ( E \tilde{R} )}^{T} x - \frac{γ}{2} MAD ( {\tilde{R}}^{T} x )$$
$$Ax = b , l \leq x \leq h , \\ where$$
$$MAD ( {\tilde{R}}^{T} x ) = E \vert {\tilde{R}}^{T} x - E ( {\tilde{R}}^{T} x ) \vert ;$$
utilizing the semi-parametric and discrete representation of the factor asset returns as
$$max {μ}^{T} x - \frac{γ}{2} {\sum }_{t} {\sum }_{v} ( {u}_{tv}^{+} + {u}_{tv}^{-} ) {p}_{t} {p}_{v} \\ - {( {F}^{T} {V}_{0 t} )}^{T} x - σ ( x ) {z}_{v} + {u}_{tv}^{+} - {u}_{tv}^{-} = 0 , {u}_{tv}^{+} , {u}_{tv}^{-} \geq 0 , ∀ t , v$$
$$Ax = b , l \leq x \leq h ,$$
where σ(x)=\sqrt{x^{T}Σx}; and
utilizing a gradient-based nonlinear optimization program running on a processor to determine mean-risk portfolio optimization with MAD as the risk measure.

10. The method of claim 1, further comprising determining mean-risk portfolio optimization with a factor model representation of asset returns, comprising the steps of:
defining mean-risk portfolio optimization with mean-absolute-moment (MAM) as the risk measure as
$${max ( E \tilde{R} )}^{T} x - \frac{γ}{2} {MAM}_{q} ( {\tilde{R}}^{T} x )$$
$$Ax = b , l \leq x \leq h , \\ where$$
$${MAM}_{q} ( {\tilde{R}}^{T} x ) = E {\vert {\tilde{R}}^{T} x - E ( {\tilde{R}}^{T} x ) \vert}^{q} , q > 1 ;$$
utilizing the semi-parametric and discrete representation of the factor model returns as
$$max {μ}^{T} x - \frac{γ}{2} {\sum }_{t} {\sum }_{v} ( {u}_{tv}^{+} + {u}_{tv}^{-} ) {p}_{t} {p}_{v} \\ - {( {F}^{T} {V}_{0 t} )}^{T} x - σ ( x ) {z}_{v} + {u}_{tv}^{-} - {u}_{tv}^{-} = 0 , {u}_{tv}^{+} , {u}_{tv}^{-} \geq 0 , ∀ t , v$$
$$Ax = b , l \leq x \leq h$$
where σ(x)=\sqrt{x^{T}Σx}; and
utilizing a gradient-based nonlinear optimization program running on a processor to determine mean-risk portfolio optimization with IMAM as the risk measure.

11. The method of claim 1, further comprising determining mean-risk portfolio optimization with a factor model representation of asset returns, comprising the steps of:
defining mean-risk portfolio optimization with semi-variance (σₛₑₘᵢ²) as the risk measure as
$${max ( E \tilde{R} )}^{T} x - \frac{γ}{2} {σ}_{semi}^{2} ( {\tilde{R}}^{T} x )$$
$$Ax = b , l \leq x \leq h , \\ where$$
$${σ}_{semi}^{2} ( {\tilde{R}}^{T} x ) = E {min ( {\tilde{R}}^{T} x - E ( {\tilde{R}}^{T} x ) , 0 )}^{2} ,$$
and where only portfolio return outcomes smaller than the expected return are considered in the variance determination;
utilizing the semi-parametric and discrete representation of the factor asset returns as
$$max {μ}^{T} x - \frac{γ}{2} {\sum }_{t} {\sum }_{v} {u}_{tv}^{2} {p}_{t} {{p}_{v} \\ ( {F}^{T} {V}_{0 t} )}^{T} x + σ ( x ) {z}_{v} + {u}_{tv} \geq 0 , {u}_{tv} \geq 0 , ∀ t , v$$
$$Ax = b , l \leq x \leq h ,$$
where σ(x)=\sqrt{x^{T}Σx}, end where V₀ₜ is the demeaned part of the factor return; and
utilizing a gradient-based nonlinear optimization program running on a processor to determine mean-risk portfolio optimization with semi-variance (σₛₑₘᵢ²) as, the risk measure.

12. The method of claim 1, further comprising determining mean-risk portfolio optimization with a factor model representation of asset returns, comprising the steps of:
defining mean-risk portfolio optimization with lower partial moment (LPM_{q}w) of the power q as the risk measure as
$${max ( E \tilde{R} )}^{T} x - \frac{γ}{2} Risk ( {\tilde{R}}^{T} x )$$
$$Ax = b , l \leq x \leq h , \\ where$$
$${LPM}_{qW} ( {\tilde{R}}^{T} x ) = {E ( - min ( {\tilde{R}}^{T} x - W , 0 ) )}^{q} , q \geq 1 ,$$
where W is a predefined value of return and risk is considered as the expected value of the negative under-performance with respect to a fixed level W raised to the power of q;
utilizing the semi-parametric and discrete representation of the factor asset returns as
$$max {μ}^{T} x - \frac{γ}{2} {\sum }_{t} {\sum }_{v} {u}_{tv}^{q} {p}_{t} {{p}_{v} \\ ( {F}^{T} {V}_{t} )}^{T} x + σ ( x ) {z}_{v} + {u}_{tv} \geq W , {u}_{tv} \geq 0 , ∀ t , v$$
$$Ax = b , l \leq x \leq h$$
where σ(x)=\sqrt{x^{T}Σx} and where W is a predefined constant;
for q=1, utilizing a linear optimization program running on a processor to determine mean-risk portfolio optimization with the lower partial moment (LPM_{q}W) of the power q as the risk measure; and
for q>1, utilizing a gradient-based nonlinear optimization program running on a processor to determine mean-risk portfolio optimization with the lower partial moment (LPM_{q}w) of the power q as the risk measure.

13. The method of claim 1, further comprising determining mean-variance portfolio optimization with a factor model representation of asset returns having a risk constraint with CVaR as the risk measure, comprising the steps of:
defining a CVaR constraint as part of a mean-variance portfolio, optimization as
$$max {μ}^{T} x - \frac{γ}{2} {x}^{T} ( {F}^{T} {M}_{\tilde{V}} F + \sum ) x$$
$$Ax = b , l \leq x \leq h$$
$$W + \frac{1}{α} {\sum }_{t} {\sum }_{v} {u}_{tv} {p}_{t} {p}_{v} \leq {ρ \\ ( {F}^{T} {V}_{t} )}^{T} x + σ ( x ) {z}_{v} + {u}_{tv} + W \geq 0 , {u}_{tv} \geq 0 , ∀ t , v ,$$
where ρ is a given maximal Value-at-Risk level; and
utilizing a gradient-based nonlinear optimization program running on a processor to determine mean-risk portfolio optimization having a risk constraint with CVaR as the risk measure.

14. The method of claim 1, further comprising determining expected utility optimization with a factor model representation of asset returns having a risk constraint with Conditional-Value-at-Risk (CVaR) as the risk measure, comprising the steps of:
defining a CVaR constraint as part of the expected utility maximization as
$$max {\sum }_{t} {\sum }_{v} u ( 1 + {R}_{Ft}^{T} x + σ ( x ) {z}_{v} ) {p}_{t} {p}_{v}$$
$$Ax = b , l \leq x \leq h$$
$$W + \frac{1}{α} {\sum }_{t} {\sum }_{v} {u}_{tv} {p}_{t} {p}_{v} \leq {ρ \\ ( {F}^{T} {V}_{t} )}^{T} x + σ ( x ) {z}_{v} + {u}_{tv} + W \geq 0 , {u}_{tv} \geq 0 , ∀ t , v ,$$
where ρ is a given maximal Value-at-Risk level; and
utilizing a gradient-based nonlinear optimization program running on a processor to determine expected utility maximization having a risk constraint with CVaR as the risk measure.

15. The method of claim 1, further comprising the steps of:
defining skewness as
$$Skew = \frac{{E ( {\tilde{R}}^{T} x - E ( {\tilde{R}}^{T} x ) )}^{3}}{{( {E ( {\tilde{R}}^{T} x - E ( {\tilde{R}}^{T} x ) )}^{2} )}^{\frac{3}{2}}} ;$$
constraining skewness to be greater than or equal to a given lower bound Skewₗ;
defining a variable uₜᵥ representing the demeaned portfolio returns as
vₜᵥ=(F^{T}V₀ₜ)^{T}x+σ(x)zᵥ,
where σ(x)=\sqrt{x^{T}Σx}; and
utilizing the factor model asset returns and its discrete representation as
$${\sum }_{t} {\sum }_{v} {u}_{tv}^{3} {p}_{t} {p}_{v} - {{Skew}_{l} ( {\sum }_{t} {\sum }_{v} {u}_{tv}^{2} {p}_{t} {p}_{v} )}^{\frac{3}{2}} \geq 0$$
to determine a skewness constraint, wherein the skewness constraint simplifies if skewness is constrained to be nonnegative (Skew≥0) as
$${\sum }_{t} {\sum }_{v} {u}_{tv}^{3} {p}_{t} {p}_{v} \geq 0 ; and$$
applying the skewness constraint to the portfolio asset returns \tilde{R}^{Tx}.

16. The method of claim 1, further applying a kurtosis constraint on the distribution of portfolio returns \tilde{R}^{T}x, comprising the steps of:
defining kurtosis as
$$Kurt = \frac{{E ( {\tilde{R}}^{T} x - E ( {\tilde{R}}^{T} x ) )}^{4}}{{( {E ( {\tilde{R}}^{T} x - E ( {\tilde{R}}^{T} x ) )}^{2} )}^{2}} ;$$
constraining kurtosis to be less than or equal to a given upper bound Kurtₕ;
defining a variable vₜᵥ representing the demeaned portfolio returns as
vₜᵥ=(F^{T}V₀ₜ)^{T}x+σ(x)zᵥ,
where J(x)=\sqrt{x^{T}Σx}; and
utilizing the factor model asset returns and its discrete representation as
$${\sum }_{t} {\sum }_{v} {u}_{tv}^{4} {p}_{t} {p}_{v} - {{Kurt}_{h} ( {\sum }_{t} {\sum }_{v} {u}_{tv}^{2} {p}_{t} {p}_{v} )}^{2} \leq 0$$
to determine a kurtosis constraint; and
applying the kurtosis constraint to the portfolio asset returns \tilde{R}^{T}x.

17. The method of claim 1, further comprising, the steps of:
incorporating at least one derivative security [symbol] as part of the portfolio of financial assets, wherein the at least one derivative security is selected from the group of derivative securities consisting of options, forwards, futures, and swaps, whose price depends on the price of an underlying security, with an asset return re depending on the underlying portfolio xu represented as
rₗ=fₗ(\tilde{R}^{T}x_{U}),
where fₗ(·) is the return generating function of the at least one derivative security [symbol] and \tilde{R}_{U}=\tilde{R}^{T}x_{U};
defining f as the n_{d}-vector of return generating functions of derivative securities and y as the n_{d}-vector of holdings of the derivative securities;
maximizing the expectation of a function G of asset returns of the portfolio comprising the derivative securities as
max EG(\tilde{R}^{T}x+f^{T}(\tilde{R}^{T}x_{U})y)
subject to portfolio, constraints on n n_{d} assets;
utilizing the semi-parametric discrete factor model representation of asset returns to represent the expectation as
$$max {\sum }_{t} {\sum }_{{v}_{1}} {\sum }_{{v}_{2}} G ( {R}_{Ft}^{T} x + σ ( x ) {z}_{{v}_{1}} + {f}^{T} ( {R}_{Ft}^{T} {x}_{U} + {σ}_{U} ( {c}_{xU} {z}_{{v}_{1}} + \sqrt{1 - {c}_{xU}^{2}} {z}_{{v}_{2}} ) ) y ) {p}_{t} {p}_{v 1} {p}_{v 2} ,$$
where ζ₁=(zᵥ_{₁}, pᵥ_{₁}) and ζ₂=(zᵥ_{₂},pᵥ_{₂}) are discrete approximations of the independent unit normal random variables z₁ and z₂; and
optimizing the expectation subject to portfolio constraints on all n+n_{d} assets.

18. The method of claim 1, further comprising the steps of:
defining a forward-looking Sortino Ratio of the portfolio x_{P} as
$$SoR = \sqrt{{n}_{Y}} \frac{E ( {\tilde{R}}^{T} {x}_{P} - {r}_{f} )}{\sqrt{{E [ min ( {\tilde{R}}^{T} {x}_{P} - {r}_{f} , 0 ) ]}^{2}}} ;$$
utilizing the semi-parametric and discrete representation of the factor model asset returns for the portfolio x_{P},
R_{Ptv}=R_{Ft}^{T}x_{P}+σ(x_{P})zᵥ; and
determining the forward-looking Sortino Ratio of the portfolio x_{P} as
$$SoR = \sqrt{{n}_{Y}} \frac{{\sum }_{t} {R}_{FPt} {p}_{t} - {r}_{f}}{\sqrt{{\sum }_{t} {\sum }_{v} {[ min ( {R}_{Ptv} {z}_{v} - {r}_{f} , 0 ) ]}^{2} {p}_{t} {p}_{v}}} ,$$
where rⱼ is the forward-looking risk-free rate and n_{Y} is the number of observations per year used for the estimation of the factor model;
wherein Tm forward-looking return realizations with corresponding probability pₜpᵥ, are used to represent the forward-looking asset returns distribution of the portfolio x_{P}; and
wherein the Sortino Ratio is the scaled ratio of the excess returns over the risk-free rate r_{f} divided by the downside target standard deviation and is expressed in annual terms.

19. The method of claim 1, further comprising the steps of:
defining a downside target standard deviation corresponding to the square root of the lower partial moment of order 2 of \tilde{R}^{T}x_{P} for portfolio asset returns \tilde{R}^{T}x_{P} as
\sqrt{E[min(\tilde{R}^{T}x_{P}−r_{f},0)]²};
utilizing the semi-parametric and discrete representation of the factor model asset returns for the portfolio x_{P}
R_{Ptv}=R_{Ft}^{T}x_{P}+σ(x_{P})zᵥ; and
determining the downside target standard deviation as
$$\sqrt{{\sum }_{t} {\sum }_{v} {[ min ( {R}_{Ptv} - {r}_{f} , 0 ) ]}^{2}} {p}_{t} {p}_{v} ,$$
where r_{f} is the forward-looking risk-free rate, and the downside target standard deviation may be annualized by multiplying by \sqrt{n_{Y}}.

20. The method of claim 1, further comprising the steps of:
utilizing the semi-parametric and discrete representation of factor model asset returns with its corresponding probabilities,
R_{Ptv}=R_{FPt}+σ_{P}zᵥpₜᵥ=pₜpᵥ;
determining a Value-at-Risk (VaR_{α}) by sorting the outcomes of R_{Ptv}, from the smallest to the largest value, maintaining the corresponding pₜᵥ; and
utilizing the sorted outcomes rⱼ, j=1, . . . , Tm, where j=1 is the smallest value; and
determining the cumulative probabilities Pⱼ as
$${P}_{j} = {\sum }_{k = 1}^{j} {p}_{k} ,$$
where the smallest index j* for which Pⱼ equals or exceeds α is found: if P_{j*}=α, then VaR_{α}=r_{j*}. and if P_{j*}>α, then VaR_{α}=r_{j*+1}.

21. The method of claim 1, further comprising the step of:
determining the Conditional-Value-at-Risk as
$${CVaR}_{α} = \frac{1}{α} {\sum }_{j = 1}^{{j}_{α}} {r}_{j} {p}_{j} ,$$
where j_{α}=j|r(j)=VaR_{α}. by summing the sorted returns up to the index j for which the return r(j) is the VaR_{α} value and by dividing the sum by α.

22. The method of claim 1 wherein the factor model of asset returns is defined for asset risk premia \tilde{R}ₜ−r_{ft}e, corresponding to excess returns over the risk-free rate, r_{ft}, such that at each rime t≥1. risk premia follow the factor model:
(\tilde{R}ₜ−r_{ft}e)=\tilde{F}ₜ^{T}\tilde{V}ₜ+\tilde{ε}ₜ,
where r_{ft} is the risk-free rate at period t, and e is an n-vector of ones.
